(19) United States
(12) Patent Application Publication
(10) Pub. No.: US 2024/0007345 A1
(43) Pub. Date: Jan. 4, 2024

(54) System and Method of Collaboratively Processing Occurrences of Events

(71) Applicant: Jia-Jen WANG, Hsinchu City (TW)

(72) Inventor: Jia-Jen WANG, Hsinchu City (TW)

(21) Appl. No.: 18/216,161

(22) Filed: Jun. 29, 2023

Related U.S. Application Data
(60) Provisional application No. 63/357,656, filed on Jul. 1, 2022.

(51) Int. Cl. H04L 41/069; G06F 16/21

(52) U.S. Cl. CPC H04L 41/069; G06F 16/211

(57) ABSTRACT

A system of collaboratively processing occurrences of events is configured to perform the following operations: transmits information of the occurrence to Asteroid_Clump_on_Duty (ACOD) and some clumps; perform a format verification, a Tally_sufficiency verification, a validation on the occurrence; each clump that performs the validation successfully claims and notifies the ACOD, Asteroid_Clump_of_Backup (ACB), and all clumps on a transmission path; performs a check on the validation; writes the occurrence data to a Satellite_Globule_Cluster (SGC) globule data structure in response to checking that the number of the passing count based on the types of clump is greater than a required threshold, wherein the SGC globule data gradually forms a Satellite_Globule_Cluster data structure. Some ACOD compete in a contest in order to write the occurrence data in Satellite_Globule_Cluster to Cardinal_Globule_Cluster(CGC).

### TECHNICAL FIELD

This disclosure relates to services in general, such as transportation, accommodation, dining service, medical service, etc. It is particularly related to systems and methods for edge computing related services.

### BACKGROUND

There are many resources that are not fully properly utilized. Considering academic scenarios, students who live around campus usually go somewhere else during school holidays, leaving residence vacant. In the business scenarios, employees living in staff housing do not live there during business trips, leaving the dormitories vacant. For most campuses or enterprises, there are usually very few restaurants or hotels nearby, so that visitors to the campus or the office cost more on dining or accommodation near them, or need to find a hotel far away from the campus or office. It not only spends plenty of time going back and forth between campus and hotel, but also wastes a lot of energy during the transportation. Therefore, the concept of exchange may be applied to these scenarios. For example, by means of exchange, academic visitors stay in vacant dormitory around campus, or business visitors stay in vacant staff housing. The computer and network system may be used to ameliorate and enhance these service and application.

In terms of adopting computer and network to implement these service application, there are many limitations and disadvantages on current systems, such as high latency of network data transmission, high bandwidth requirements, high power consumption, limited data processing speed, data modification complicacy, data backup inconvenience, and possible data tampering. There are usually many problems in client server system. It can be problematic when there are large amounts of data (such as videos or images) to be sent to central server. Many of these add up to require extremely huge bandwidth to connect to the central server. The service would be unavailable when the central server and bandwidth cannot fulfill the incoming demand.

Therefore, it is essential to improve the limitations and shortcomings mentioned above and to optimize the entire process. This is the background intention of this disclosure.

### BRIEF DESCRIPTION OF THE DRAWINGS

FIG. 1 illustrates a system of collaboratively processing occurrences of events according to an embodiment of the present disclosure.

FIG. 2 illustrates a communication device according to an embodiment of the present disclosure.

FIG. 3 illustrates a flow chart of the operation process of an embodiment of the present disclosure.

FIG. 4A and FIG. 4B illustrate a flow chart of the process of an embodiment of the present disclosure.

FIG. 5 illustrates a flowchart of packet transmission of clumps on the transmission path an embodiment.

FIG. 6 illustrates a diagram of the data structure of Cardinal_Globule_Cluster of an embodiment of the present disclosure.

FIG. 7 illustrates a diagram of the data structure of Satellite_Globule_Cluster of an embodiment of the present disclosure.

FIG. 8 illustrates a diagram of the contest of Satellite_Globule_Clusters on writing data to Cardinal_Globule_Cluster of an embodiment of the present disclosure.

FIG. 9A illustrates a flowchart of a validation method of an embodiment of the present disclosure.

FIG. 9B illustrates a lookup-table of an embodiment of the present disclosure.

FIG. 9C illustrates a flowchart of another validation method of an embodiment of the present disclosure.

FIG. 10 illustrates a diagram of the archive process of Cardinal_Globule_Cluster of an embodiment of the present disclosure.

FIG. 11 illustrates a table of data storage based on the level of impact of an embodiment of the present disclosure.

FIG. 12 illustrates a diagram of fault tolerance of an embodiment of the present disclosure.

FIG. 13 illustrates a Tally_sufficiency checking process of an example of accommodation service of an embodiment of this system.

FIG. 14 illustrates an example of accommodation service through an embodiment of this system.

FIG. 15 illustrates an example of column hash_previous_n_globule.

FIG. 16 illustrates a diagram of supply-demand situation of vehicle location dynamically updating to Edge_Cloud.

### DETAILED DESCRIPTION

### [Preliminary: Term Explanation]

Some computers or processing devices running the software of this system may be connected to form a network for the operation of this system. The terms in this disclosure are explained: System: The system is named as Astronomic-Galactic-River (AGR).

### Asteroid_Clump and Meteoroid_Clump:

In this architecture, there are two type of clumps for Astronomic-Galactic-River system. First type of clump is Asteroid_Clump (AC) which is operated by a participating organization such as a university, a research center, a medical center, a company that participate in this system, a franchise store (e.g. Dominos and McDonalds). Asteroid_Clumps are usually servers, (or POS connected to server through network), with high capability of computing and storage. The other type of clump is Meteoroid_Clump (MC) that is operated by a registered member in the system. The users of Meteoroid_Clump can be a student, a faculty member, a researcher, a medical staff, or an employee of a company. Meteoroid_Clumps are usually personal computers, workstation, tablets, or mobile devices that may perform computing tasks.

Asteroid_Clump_on_Duty (ACOD): Asteroid_Clump_on_Duty performs the duty of primarily tasks. (Stage-1: one Asteroid_Clump on duty per region; Stage-2: one Asteroid_Clump_on_Duty per sub-region).

Asteroid_Clump_of_Backup (ACB): Asteroid_Clump_of_Backup serves two functions: takes the duty of secondary tasks when there is something wrong with Asteroid_Clump_on_Duty. Asteroid_Clump_of_Backup immediately performs all tasks of Asteroid_Clump_on_Duty. (Stage-1: one Asteroid_Clump_of_Backup per region; Stage-2: one Asteroid_Clump_of_Backup per sub-region).

Core_Cloud: the cloud that handles computing and storage for system core.

Edge_Cloud: local cloud which does edge computing and stores for local occurrence.

Stakeholder: Asteroid_Clump and Meteoroid_Clump are all stakeholders. The clumps possess large amount of Astronomic-Galactic-River tally may be considered as primary stakeholder. The clumps possess less amount of system tally may be considered as secondary stakeholder. The cutoff point of large and less depends on the application.

Globule: components in a globule: (1) conspectus of a globule; (2) constituent of a globule, which is composed of occurrence data.

Sphere: A sphere contains many globules within.

Sphere_circle: a progress of many globules forming a shape of circle on a sphere. Sphere_circle may be considered as a cross-section of the sphere. For some applications, different sphere_circles in a sphere may represent different category based on their characteristics.

Cardinal_Globule_Cluster (CGC): primary Globule Cluster, consisting of many spheres (CGC-spheres); many CGC-globules are within each sphere.

Satellite_Globule_Cluster (SGC): for low-impact occurrences, consisting of many spheres (SGC-spheres); many SGC-globules are within each sphere.

Prill: A globule of Satellite_Globule_Cluster consists of prills where detail low-impact occurrence data are placed.

Format Verification: The data format of occurrence data need to verified first. The verification is performed before validation. Clumps do not work on validation if the verification does not pass.

Hash: The hash function used in this system is not restricted, depending on application. Keccak-512 is an example of hash function that could be used in this system.

Tally-sufficiency check: whether the remaining tally of a member in the system is sufficient for this occurrence at this moment.

Validation: After a set of occurrence data is verified by clumps through format verification and Tally_Sufficiency check, the set of occurrence are placed in the buffer. The validation of globule is performed after all occurrence data in the buffer of globule have been verified. If a requirement of validation is met, the globule is considered validated.

Validation-check: When a clump claims that it validates a globule with occurrence data within successfully, the clump informz some relevant clumps. These clumps receive this message and do Validation-check to check whether the successful validation a globule is true. After these clumps finish the Validation-check, these clumps would inform relevant clumps (including Asteroid_Clump_on_Duty, Asteroid_Clump_of_Backup, and some relevant clumps with proximity) that the Validation-check has been done.

User identification in application: In an embodiment of system, users are all registered members in participating institutions (such as university, research organization, medical center), including registered faculty, registered researchers, registered employees, registered students, registered stores around the campus (the stores participating in the system), and the companies that participate in this system. All users may be identified and tracked if there is a security issue.

### Preliminary System Operation of Embodiments

The description of many features spanning multiple sections and headings should not be read as affecting the meaning of the description included in any section.

The system provides an enhancement and optimization on edge cloud computing. The system is scalable. Each occurrence needs to be verified and validated by a certain number of validators. There are two types of clumps: One is Asteroid_Clump; the other is Meteoroid_Clump. The operation of system primarily relies on the collaboration task of Asteroid_Clump, Meteoroid_Clump, and Edge_Cloud. When a set of occurrence data is sent to some clumps, these clumps do the verification first. The format of occurrence data need to be verified first. The clumps verify whether the remaining tally of a member is sufficient to meet the requirement of Tally-sufficiency. These clumps try to validate the occurrence.

### Clump Selection:

In an embodiment, stage-1 can be considered as a temporary transitional stage. During stage-1, the selection of Asteroid_Clump_on_Duty and Asteroid_Clump_of_Backup for each region is round-robin, and the selection is done by the committee of the system. Every eligible Asteroid_Clump need to perform the job of Asteroid_Clump_on_Duty and Asteroid_Clump_of_Backup by turn, (for example, each takes the responsibility for one month). After the selection, the IP addresses of Asteroid_Clump_on_Duty and Asteroid_Clump_of_Backup are broadcasted to all clumps in all regions. Therefore, all clumps know which clumps are Asteroid_Clump_on_Duty and Asteroid_Clump_of_Backup. During stage-2, there are many sub-regions in each region. There are one Asteroid_Clump_on_Duty and one Asteroid_Clump_of_Backup working as local processing center in each sub-region.

Advantage of clump selection: The mechanism of clump selection may reduce the impact of malicious attack based on its dynamic characteristics. There are various methods for the selection of Asteroid_Clump of local processing center. Which method is applied depends on the type of application.

The methods of selection of Asteroid_Clump comprise the following:
(1) The Asteroid_Clump that is closest to the Receiver_of_Occurrence of occurrence by physical location and proximity. (close-by Asteroid_Clump)
(2) Credit of the Asteroid_Clump: The Asteroid_Clump with better credit index on performing the tasks of the system has higher probability to be elected by the primary stakeholders. For example, an Asteroid_Clump usually do very well in validating and on_duty tasks. The credit index of this Asteroid_Clump is quite high (for example, 90, credit index: ranging from 0˜100). The Asteroid_Clumps whose credit index is higher than 70% on the percentile are considered as candidate of Asteroid_Clump of local processing center. Each quarter, the primary stakeholders elect some of the candidates (with high credit index) to become Asteroid_Clumps of local processing centers.
(3) Voted by Meteoroid_Clumps: Meteoroid_Clumps also act as monitoring role for the system operation. The Asteroid_Clumps of local processing centers may be voted by all active Meteoroid_Clumps. If there are some Meteoroid_Clumps who are idle and do not perform tasks for the system for more than a month, these Meteoroid_Clumps are not eligible for voting.

Asteroid_Clump generally refers to Full_Function_Asteroid_Clump (FFAC). There is another type of Asteroid_Clump which only do certain tasks, but not all task. It is called Partial_Function_Asteroid_Clump. For example, the shop in campus may act as a Partial_Function_Asteroid_Clump. However, it cannot perform the duty of Asteroid_Clump_on_Duty. In other words, it cannot write data onto Cardinal_Globule_Cluster.

### Proximity:

The degree of proximity between an occurrence and the validator is determined by these two factors.
(1) Internet Protocol address: For the heading of IP address is the same, it is considered as with higher proximity.
(2) Physical location: When the validator is in the same geographical area (such as the same county for high population density areas, or the same province for low population density areas) where the occurrence occurs, it is high degree of proximity. The choice of clumps that receive occurrence data is related to physical location where the occurrence is initialed (except high-impact occurrence).

### Proximity of Asteroid_Clump:

The registered location of Asteroid_Clump is used in the category of high-impact occurrence data. When an Asteroid_Clump registered to the system, the physical location of this Asteroid_Clump is recorded in the system. If the Asteroid_Clump change its location, the new physical location need to be updated to the system.

### Proximity of Meteoroid_Clump:

The registered location of Meteoroid_Clump is used in the category of high-impact occurrence data. The temporary location of Meteoroid_Clump is used for the category of medium-impact and low-impact occurrence data. The temporary location of Meteoroid_Clump is determined by the network (wireline/wireless) through IP address. When physical location and proximity is considered, the traffic of network would be less. The traffic does not need to go a long way through many switching/routing processes. Therefore, there would be less energy consumed.

### Occurrence and Impact

Since there are various applications, such as housing and accommodation, supply chain, transportation, energy, virtual interactive sphere, and healthcare. For occurrence data, there could be different meanings for different applications. Though it may be considered as the equivalence of dollar amount in occurrence data in financial related service, it often refers to other things here. In this system, it is a concept of exchanging something with the other thing in general. For various types of applications, we may consider either the impact of an occurrence, the importance of an occurrence, the gain of an occurrence, or the loss of an occurrence. If the loss would be high when one occurrence data is corrupted, we may consider the impact of the occurrence is high. For example, the occurrence could be the privilege of residence of a room of a building for a certain period of time. The equivalence of this occurrence may be considered as the average rental price of similar condition within that area for that period of time. If it is considered as the equivalence of gold/dollar amount in occurrence data in daily financial related service, the way to consider the impact could be like this: The Sender_of_Occurrence looks at the average or medium value of the equivalence of occurrence data within a few months. (This service may be provided by cloud.)

The Sender_of_Occurrence claims the impact of this occurrence, which is called impact-claim in this system. If the Receiver_of_Occurrence agrees with this impact-claim, the Receiver_of_Occurrence informs the Sender_of_Occurrence his accord regarding this occurrence. The impact-claim also need to get endorsement from Asteroid_Clump_on_Duty except the occurrence is taken placed in All-Impact-Low store (for accommodation/dining/retail application). Since almost all low-impact occurrences take place in All-Impact-Low store, there are very few scenarios that impact-claim of occurrences need to be sent to and get endorsement from Asteroid_Clump_on_Duty for low-impact occurrences.

Each occurrence in this system is an occurrence of an event of this application system. The way to validate a globule is processed by certain method described in validation section. The validators would get the gratuity-tally for successfully validating an occurrence provided by Sender_of_Occurrence. The amount of gratuity-tally is a weighted value based on the following criteria:
(1) Correct computation but not fast enough: In general, there are more gratuity-tally if a clump does more correct computation (historical amount of globule validations of correct computation). The computation is correct, however:
   (a) this globule is not eventually counted on the longest branch (with consideration of hardness).
   (b) the clump completes computation and meets the requirement of validation, but not fast enough (almost the same time, but not on the list of first several clumps required for the minimum amount of clump). In such case, the clump may claim this correct computation by sending message to Asteroid_Clump_of_Backup that will check and keep record on cloud.
(2) Incentive for Meteoroid_Clumps: determined by the system. There is more gratuity-tally for Meteoroid_Clump; less gratuity-tally for Asteroid_Clump. The reason of more gratuity-tally for Meteoroid_Clump is to balance the computing capability of two types of clumps. In other words, the system would like to encourage Meteoroid_Clumps to contribute to the system so that the system is not dominated by the Asteroid_Clumps.

### Deposit

In an example embodiment, at the time of registration, a user of a clump needs to prepare a certain amount of gold or gold equivalent money for deposit. The deposit is kept by the system and would be used in case there is an unbalance after the occurrence. For example, the user of a Meteoroid_Clump originally intended to use a service (service_1) (for example, a speech, a lecture, or a demonstration), for exchange for a housing or dining service (service_2). However, the service_1 could not take place for some reason. The person already used the service of dining (or housing) (service_2). The deposit of the user of a Meteoroid_Clump provided upon registration can be applied as an exchange item for that dining (or housing) service that already be consumed.

### Region and Registration

The registration region of a Sender_of_Occurrence or a Receiver_of_Occurrence is the region of the institution where the individual registers his account. The current region of a Sender_of_Occurrence or a Receiver_of_Occurrence is the region where the clump is currently located. The region definition depends on the application of the system. In an embodiment of service of housing accommodation among international institutions, it can be defined as regions (for example, 150˜250 regions in the world). After the system operates for a certain period of time, the amount of occurrence is quite large. The system goes to stage two. There are sub-regions in each region in stage two. In general, there are tens of sub-regions within each region. (The sub-region assignment depends on the geographical condition, population density, amount of members) (for example, 60˜100 sub-regions in a region).

### Impact

In an embodiment, which validation method is applied to a service is determined by the impact applicable to that specific service. The impact is related to the importance of an occurrence, the gain of an occurrence, the loss of an occurrence. In an embodiment, impact may be considered as the impact or gain/loss when there is something good/wrong in this occurrence. The impact evaluation depends on the type of application and the scheme of impact evaluation that could be modified based on economic environment. For example, in the service of housing/accommodation/retail among international institutions in this system, the impact is evaluated by the occurrence value equivalent to gold in an occurrence. In an embodiment, it is classified into several levels. (The cutoff-value of category depends on the application. They are not fixed numbers. It is determined in regular meeting of major stakeholders of system.) It may be designed by other approach/method. The level classification is simply in an embodiment and is meant to be exemplary only, and not meant to limit implementations of the invention described and/or claimed in the present application.
(i) When the value of an occurrence equal or larger than the value equivalent to 500 gram of 24 carat gold (around 30000 USD), the impact level is considered as high.
(ii) When the value of an occurrence less than 500 gram of 24 carat gold equivalent and larger than the value equivalent to 5 gram of 24 carat gold (around 300 USD), the impact level is considered as median.
(iii) When the value of an occurrence equal or less than the value equivalent to 5 gram of 24 carat gold, the impact level is considered as low.

There is a field of variable in data field of conspectus “impact_category”. At the time of occurrence, the Sender_of_Occurrence and the Receiver_of_Occurrence need to determine the category of impact based on the impact of this occurrence and get agreement from Asteroid_Clump_on_Duty. Which clumps the occurrence data would go to and which flow the process would go are determined based on this value of impact_category.

For the low-impact scenario, the occurrences are to be temperately saved by Satellite_Globule_Cluster after sufficient validation. Asteroid_Clump_on_Duty and Asteroid_Clump_of_Backup at Receiver_of_Occurrence region handle the Satellite_Globule_Cluster of occurrence data. The validation for low-impact scenario is based on the concept of less hardness. The hardness target set for the low-impact process is much less than the hardness target set for the median or high impact process. After accumulating for a certain amount of globules, these SGC_globules with low_impact_occurrences are written onto the Cardinal_Globule_Cluster. The dollar value of each occurrence of the low-impact process is less than that of median or high impact process. The reduced hardness can result in less validation process time. It can be considered as a valid occurrence as long as it is validated in the low-impact process on Satellite_Globule_Cluster before it is consolidated on to the Cardinal_Globule_Cluster. This mechanism may reduce overall occurrence processing time.

### Network

In an embodiment, the occurrence data is propagating through the following process. As described above, the occurrence data is generated by the Sender_of_Occurrence's device and the Receiver_of_Occurrence's device. And the occurrence data is sent to Asteroid_Clump_on_Duty, Asteroid_Clump_of_Backup, some Asteroid_Clumps and the Meteoroid_Clumps that are in the table.

Each clump establishes a table of some clumps. Asteroid_Clump_on_Duty and Asteroid_Clump_of_Backup are included in the table. Some adjacent Asteroid_Clump and adjacent Meteoroid_Clumps are included in the table.

As a clump initiates, this clump need to inform Asteroid_Clump_on_Duty and Asteroid_Clump_of_Backup its IP address and status. If this clump does not know Asteroid_Clump_on_Duty and Asteroid_Clump_of_Backup, this clump may ask a few neighbor clumps around and get the information of Asteroid_Clump_on_Duty and Asteroid_Clump_of_Backup. Once it communicates with Asteroid_Clump_on_Duty and Asteroid_Clump_of_Backup, Asteroid_Clump_on_Duty and Asteroid_Clump_of_Backup will inform this clump necessary information including information of some adjacent Asteroid_Clump and adjacent Meteoroid_Clumps.

Every clump needs to keep track of its current IP address and MAC address. If any clump changes its IP address or anything wrong with its MAC address, the clump need to inform Asteroid_Clump_on_Duty and Asteroid_Clump_of_Backup. The Asteroid_Clump_on_Duty and Asteroid_Clump_of_Backup will inform some clumps that are related to this clump about this new IP address of this clump and its status.

Every clump maintains two tables of IP address of clumps: one Asteroid_Clumps table, one Meteoroid_Clumps table. (Asteroid_Clumps and Meteoroid_Clumps are listed in different tables.)

For a table of Asteroid_Clumps, it lists the IP address and status information of some Asteroid_Clumps in a region. For a table of Meteoroid_Clumps, it lists the IP address and status information of some Meteoroid_Clumps in a region.

Each clump has both Asteroid_Clump table and Meteoroid_Clump table. The clump need to PING some adjacent Asteroid_Clumps and adjacent Meteoroid_Clumps that are in the tables. These clumps received the PING and reply with an ACK to let that clump know it is up-running all-right. Once a connection between clumps is established, it is easy to do any communication further.

All clumps receive the occurrence data need to do verification first: Format and Tally_sufficiency (whether the remaining tally is sufficient for this occurrence at this moment) should to be verified first.

After the format of occurrence data is verified, the clumps try to do validation. The Asteroid_Clump_on_Duty, the Asteroid_Clump_of_Backup, the plurality of Asteroid_Clumps, and the plurality of the second Meteoroid_Clump performs the validation after format verification and Tally_sufficiency check are completed. If one of the Meteoroid_Clumps validates an occurrence successfully, it will inform Receiver_of_Occurrence, and Receiver_of_Occurrence will inform all clumps in the transmission-path, Asteroid_Clump_on_Duty, and Asteroid_Clump_of_Backup. Thus, all related clumps know which clump claims the validation of this occurrence. And the following step is that it is necessary to confirm whether the validation result is valid. This is called validation-check.

Based on the impact of each occurrence, the occurrence data is sent to some Asteroid_Clumps. The Sender_of_Occurrence and Receiver_of_Occurrence know which Asteroid_Clumps the data need to be sent to. The occurrence data is sent to some specific Asteroid_Clumps directly. After Asteroid_Clumps receive the occurrence data, Asteroid_Clumps do verification of format and double spending first. Asteroid_Clumps try do validation for a set of occurrence data. Asteroid_Clumps do not forward the occurrence data to other clumps.

### Balanced Scalable Transmission and Validation Control Method

### Impact Flow:

In an example embodiment, once there is an occurrence, the Sender_of_Occurrence and the Receiver_of_Occurrence agree upon the condition of exchange and impact level. If the occurrence take place inside a retail store or a dining service (All-Impact-Low store) in the participated campus and all goods or services provided at the store or dining service are considered as the level of impact low, there is no need to get endorsement from Asteroid_Clump_on_Duty for the setting of impact level. Otherwise, the content and impact level of this occurrence must be sent to Asteroid_Clump_on_Duty and get endorsement from Asteroid_Clump_on_Duty for this impact level proposed by Sender_of_Occurrence and Receiver_of_Occurrence. After Asteroid_Clump_on_Duty endorse the impact level for this occurrence, the Receiver_of_Occurrence (Sender_of_Occurrence) starts to transmit the occurrence data to specific clumps on the list of clumps maintained by the Receiver_of_Occurrence based on the classification of impact level. According to the classification of impact level, there are two different processing flow. All occurrence must be transmitted to Asteroid_Clump_on_Duty and Asteroid_Clump_of_Backup.

### Flow-1:

For Flow-1 (Impact High-Medium occurrence), Asteroid_Clump_on_Duty place the occurrence data onto the queue-areas of Core_Cloud right after receiving occurrence data from Receiver_of_Occurrence. In Flow-1, each clump may receive the occurrence data from the source: either the queue-areas on the cloud or Receiver_of_Occurrence.

### Flow-2:

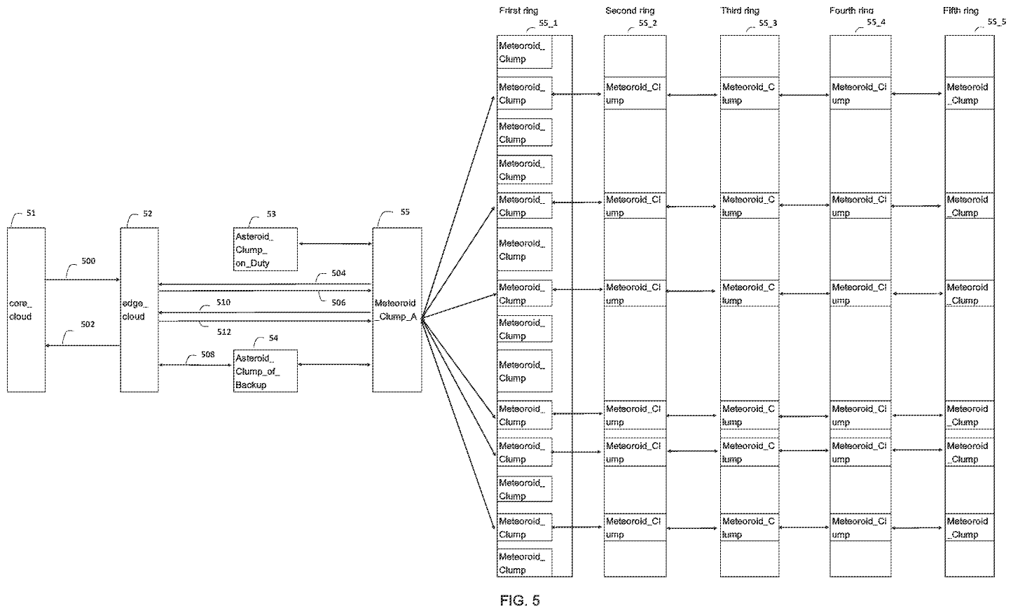

In Flow-2 each clump may receive the occurrence data from the source, Receiver_of_Occurrence. Whenever a clump receives occurrence data, the clump needs to reply to the Receiver_of_Occurrence with a ACK-of-receiving-occurrence that the clumps receives it properly, and continues to transmit it to the next ring clump. During each transmission, the clump does the same thing: adding its IP address into the field of clump IP list obtain occurrence. After the transmission of occurrence reaches fifth-ring, the clump in fifth-ring place also its IP address into the field of clump IP list obtain occurrence and send a ACK-of-receiving-occurrence to the clump of previous ring which just sent the occurrence to it. Once its previous ring of clump receives the ACK-of-receiving-occurrence, it forwards this ACK to the clump of previous ring. The process continues until the acknowledgement goes back to the original Receiver_of_Occurrence. The arrows (FIG. 5) in the same direction in the figure is a transmission-path. Occurrence is send forward along with transmission-path. And the acknowledgement is sent backward along with the transmission-path.

Each clump needs to maintain its own list of Asteroid_Clump and list of Meteoroid_Clump. It is primarily based on physical location, proximity, and transmission response. Each clump picks some close-by Asteroid_Clumps by the criteria. Each clump also picks some close-by Meteoroid_Clumps by the criteria.

The rating of network capability and hash power is provided by the system. The system periodically updates the system software and each clump may update the rating information of clumps in its list when it updates software.

In an example embodiment, the clump chooses a few among those on the list of Meteoroid_Clump to transmit occurrence data based on combination of “the rating of network capability and hash power” and “Historical Credit”, after excluding some NOT-GOOD on rating of response speed of Meteoroid_Clump on the list of Receiver_of_Occurrence. During the following rings for transmission, it also chooses the clump to transmit based on this criterion. The higher score of the combination of “the rating of network capability and hash power” and “Historical Credit”, the higher possibility the clump would be chosen to be transmitted.

Satellite-Globule-Cluster process:

Satellite-Globule-Cluster process takes place when the impact of occurrence is not high. The process is not done on the Cardinal_Globule_Cluster. Since the Asteroid clump start to process the occurrence data until 100 CGC-globules is accumulated, this is called one CGC-cycle. In the end of the cycle, the grasp of globule constituent of SGC, (which is not written onto CGC yet), will be written on the Cardinal_Globule_Cluster by the regional processing center. The good thing is the SGC allows a change of an occurrence. When there is any modification on the occurrence data, it is easy to handle these change before it is written onto the Cardinal_Globule_Cluster. For example, if there are many low-impact occurrences happening between Alice and Bob during a short period of time, the data in globule constituent could only include the first/last occurrence and the balance of these two persons in the end of that period for a certain application. When the impact is low, it goes Satellite-Globule-Cluster. It is processed by Asteroid_Clump_on_Duty first. At this time, the occurrence does not go to Cardinal_Globule_Cluster yet. The globule constituent in Satellite_Globule_Cluster is a summary, not all detail occurrence data. Detail low-impact occurrence data is only placed on prills on Edge_Cloud.

When Satellite_Globule_Cluster reaches a certain amount, the occurrence data will be written onto the Cardinal_Globule_Cluster by regional processing center by contest on tournament.

There are two types of approach in Satellite-Globule-Cluster processing. During stage-1, when the amount of occurrence is not huge, type 1 is adopted. After the system has been run for a long time, the amount of occurrence data all over the world is huge, it goes to stage-2 and type 2 is adopted.

### Type 1 Process:

At the initial stage of the system operation. The amount of Asteroid_Clump participating in the system are not many. There is one Asteroid_Clump_on_Duty and one Asteroid_Clump_of_Backup per region. The selection of Asteroid_Clump_on_Duty and Asteroid_Clump_of_Backup is done by the committee of the system. In an embodiment, the method of selecting Asteroid_Clump_on_Duty is predetermined by the system committee.

The regional processing center is the Asteroid_Clump_on_Duty. For each month, one Asteroid_Clump_on_Duty and one Asteroid_Clump_of_Backup per region are determined by the system.

There is a Satellite_Globule_Cluster for low-impact occurrence data. Occurrence data is validated through the method described (with much less hardness) by the requirement determined by the system committee. (The hardness setting of validation is less-hardness.)

After a certain period of time the grasp of globule_conspectus of Satellite_Globule_Cluster is to be written onto the Cardinal_Globule_Cluster. These low-impact occurrences in Satellite_Globule_Cluster stand alone, and detail data does not go to Cardinal_Globule_Cluster. All low-impact occurrence data is kept in Satellite_Globule_Cluster. Because the impact of these occurrence data is low, the Satellite_Globule_Cluster is only kept for a certain period of time. Depending on application, the time kept for housing/accommodation could be set as six years.

Type 2 process:

After the system has been operating for a long time, the amount of occurrence data is very large. If there is only one Asteroid_Clump_on_Duty per region, the loading of this Asteroid_Clump is too heavy. Thus, there are many sub-regions center in each region. There is one local processing center in each sub-region. There are more Asteroid_Clumps working on the task. These Asteroid_Clumps take the role of processing is called local processing center. For example, in Europe, there are many occurrence data generated in many different regions in Europe. There could be 50 regions in Europe. There could be 100 sub-regions per-region. There could be 5000 set of Asteroid_Clump_on_Duty and Asteroid_Clump_of_Backup that perform as local processing centers in Europe.

As for data compression of Satellite_Globule_Cluster, there are many Asteroid_Clump_on_Duty working in the system simultaneously. During Stage-1, there is one Asteroid_Clump_on_Duty per region. For low-impact occurrence, each Asteroid_Clump_on_Duty would obtain occurrence data. Satellite_Globule_Cluster of the region is formed. During stage-2, there is one Asteroid_Clump_on_Duty per sub-region. The data in Satellite_Globule_Cluster will be compressed after written to Cardinal_Globule_Cluster. The method of data compression depends on application. For general data, the method could be Huffman, Lempel Ziv Welch or other lossless data compression method. For image based data, discrete cosine transform (lossless) or other lossless data compression method could be applied.

### Embodiment of Transportation Energy Saving Application of AGR System of Edge_Cloud

### Background of Embodiment of Transportation Energy Saving Application

The following section is an embodiment AGR System of Edge_Cloud in transportation energy saving Application.

The availability of vehicles changes all the time. At a certain period of time. The amount of vehicles available for rent goes up and down in each location. The vehicle is a machine that transports people or cargo, which comprises automobiles, bicycles, motorcycles, boats, yachts, and aircraft.

When the amount of certain vehicles available for rent is not sufficient, some vehicles from other locations where the amount of vehicles are more than market demand may be transported here.

People sometimes need to travel from one place to the other place for a business trip, for a tour, or for other purpose. Some members may drive vehicles for the system to reduce the energy consumption of car-carrying trailer. For example, if there is a demand of one vehicle at a certain location, it would waste quite amount of gasoline or electricity to transport only one vehicle by a car-carrying trailer.

If a driver who drive one vehicle to fulfill a demand of vehicle at location_Y during first trip, and then drive another vehicle to fulfill a demand of vehicle at location_X during return trip. This would save the gas/electricity of car-carrying trailer twice, a huge saving of energy consumption.

### Motivation:

By adopting the AGR system in this disclosure;
Assisting end-user to drive the rental vehicle from one location to another location to transport the vehicle from low demand area to high demand area; (If there are several people who would like to travel from first location to the second location, these people may drive the vehicle by turn and share the effort of driving and the cost of gasoline, this is an action of energy saving);
Facilitating occurrence data processing by green power provided by participating facilities; Providing all validators reasonable rewards of AGR system.

### Current Practice:

There are many limitation and drawback on current rental service: In an area, there is short of vehicle when the end-user need to rent vehicle. The rental company need to use car-carrying trailer to transport vehicle from one place to another place. It is a very complicated process for rental sharing (and dealing with insurance matter for sharing).

### Contribution:

Based on the AGR system on this transpotation application, it may solve the problem of vehicle demand, and reduce energy consumption. The characteristics of AGR system allows this transpotation application to work properly and avoid the drawback of tranditional client-server design. (This is a win-win scenario for both Vehicle Rental company and drivers who need to travel.)
Updating and storing various types of vehicle status, routing data, and supply-demand condition properly through collaboration of Meteoroid_Clump, Asteroid_Clump, and Edge_Cloud in the AGR system.
Reducing vehicle transportation cost of Vehicle Rental company (transportation by car-carrying trailer).
Solving the problem: Consumer looking for a certain model of vehicle but cannot wait the next routine shift of car-carrying trailer.
Sharing the cost and driving effort of transportation (shared by vehicle Rental company and some AGR end-user members).
Saving the energy by car-pooling and proper arrangement of round trip driving of on-demand vehicle.

### Method of Application:

A person (Person_X) would like to rent a vehicle to travel from Location_A to Location_B. Person_X drives this vehicle from Location_A to Location_B, thus this vehicle is transported to Location_B by this person without additional transportation cost (by vehicle-carrying trailer.).

There is another person (Person_Y) who need to use this vehicle in Location_B. Before Person_X drives this vehicle to Location B, there is no such vehicle at Location B. This is win-win situation for Person_X and Person_Y since this rental trip also fulfills the demand of this vehicle in Location B.

In this case, the vehicle rental charge could be as low as possible because the vehicle rental system would instead need to pay for the cost of transportation of the vehicle by vehicle-carrying trailer. The person could only pay for the insurance fee and the cost of gasoline.

The system may provide a plan X which contains several routes and estimate time for this person to drive (or sail) from Location_A to Location_B. This plan is an optimized plan which considers some factors such as weather, road condition, gasoline filling (electric charging for electronic car) location.

If the person needs to stay in a city between Location_A and Location_B for some periods of time, the system may consider this user demand and provide another plan (plan Y) for him.

In an example, comparing plan X and Y, if the distance difference is not more than 20 percent and the time difference is not more than 30 percent, this person may choose plan Y to drive from Location_A to Location_B by stopping by a city for a period of time without additional rental charge due to the effort of this person to drive this vehicle from Location_A to Location_B. (The assumption is that the demand of this vehicle at Location_B is not urgent).

For commercial consideration, this person need to pay a vehicle rental security deposit. In this embodiment, the deposit can be done by using the AGR_tally of the system that the person owns to be placed in a temporary account. The system keeps this amount of AGR_tally until this vehicle is returned safely without damage within the required driving time and distance.

The person needs to drive this vehicle from Location_A to Location_B in a distance that is not more than 20 person of the distance that the system calculated an optimized rout in plan X. Otherwise this person will be charged a fee by deducting the deposit (AGR_tally) that was prepaid to the account in the system. As long as the person drives this vehicle within a certain distance within a certain period of time, he saves a lot of rental fee. (If some passengers share the ride with him, this is an environmentally friendly mean of transport.)

The other thing to save the cost is to the cost of gasoline by a few passengers who also want to go to the same destination at the same time. In this platform, a person may place his plan with route and time on the system, another people may look at other people's plan. If other people's plan meets his plan, he may contact the person to see if they may join this trip by sharing the cost (gas, toll fee, and others). (The passengers also share the cost of gasoline/electricity-charging, and provide the system a certain amount of payment for system operation and insurance.)

The person needs to pay for accidental insurance fee and the cost of gasoline for driving this vehicle. The person needs to fill the gasoline to the same level of the gasoline level of picking up the vehicle.

For the charge of insurance fee, if the person has sufficient AGR_tally to pay for it after using some of them for a deposit, he may choose to use AGR_tally to pay for insurance, otherwise, he still uses usual currency to pay for insurance.

### How to Pay for Vehicle Rental and Insurance:

The person would use a device after joining this system as a member. This device is Meteoroid_Clump in the system. This device may be connected to a computer, a tablet, a smart phone, a laptop through wireline/wireless connection. The device may download an application software, which may process the procedure of trip plaining, vehicle selection, payment of rental service and insurance fee.

The excess and shortage information of vehicles on each location is shown on a map. Based on a certain model of vehicle, the person may consider “where the amount of the vehicle is more than demand” as the starting location. The person may consider “where the amount of vehicle is less than demand” as the destination location.

The rental fee could be either zero or very low, depending on how urgent the vehicle is needed in destination. If the demand is urgent, or the amount of vehicle is much less than demand in destination location, the rental fee could be as low as zero, and the person might get extra bonus reward (getting extra AGR_tally).

The vehicle in this article comprises various types of transportation equipment (car, pickup, truck, U-hall, motorcycle, boat, aircraft, etc.)

User identification:
In this system, user are members who join AGR system.
the members should have driver license for the vehicle that they would use.
the members should have record of driving this kind of vehicle from either insurance record or other source.
All users may be identified and tracked if there is a security issue.

### The Way to Calculate the Supply and Demand of Vehicle:

For each location, it is called a vertex. The route connecting two locations is called an edge. The average amount of vehicles rental picked up from a certain location is called the average demand of vehicles. The amount of vehicles that is available for rental from a certain location is called the average supply of vehicles.

The surplus of each location is defined:

Surplus=Supply−Demand

### Method of Arranging Driver for Demand of Vehicle:

At a certain point of time, a member in the system would like to arrange to rent a vehicle Model_E at Location_Pickup at the time of Time Pickup. However, there is no Model_E at Location_Pickup at that time. Driver Ready are those members who are ready to drive a vehicle from one location to the other location (for a business trip, for a tour, for other purpose, or purely driving for the system).

When the system calculates route distance, it is primarily based on the physical road condition for route planning. If there is a road under construction, that road is removed from the route planning.

### Network Connection/Relay Transmission:

All vehicles in the system need to keep updating its status to the Edge_Cloud. For vehicles parking in the parking lot of Vehicle_PickupReturn_Spot, the office of the Vehicle_PickupReturn_Spot will upload the status of all vehicles parking at its spot to Edge_Cloud.

For vehicles on the road, the vehicles need to connect to network periodically in order to update its status. Each vehicle is equipped with device that receive GPS data from satellite

These network_connected_street_lights, gas/electricity_charging_stations, grocery-dining-shops, low-earth-orbit_satellite participating in AGR system, are equipped with the facility of network connection.

When there is cellular/Wi-Fi signal at the spot where the vehicle is currently located, the device may transmit and receive data from cellular/Wi-Fi network, and the data may be updated to Edge_Cloud through the cellular/Wi-Fi network.

When there is no cellular/Wi-Fi signal at the spot where the vehicle is currently located, the device may transmit and receive data to some vehicles adjacent to current location in the topology like the figure shown. The data may be transmitted as relay through one of the following:
(1) adjacent Vehicle
(2) close by Gas/Electricity Station
(3) network_connected_Street_Lights
(4) grocery_Shop.

In rural areas, there is usually no wireless network signal or very week wireless network signal. While driving around these rural areas, vehicle may transmit its status to network_connected_street_lights. These network_connected_street_lights may transmit signal as relay from one network_connected_street_lights to the other network_connected_street_lights. When the driver drives the vehicle to gas/electricity_charging_stations, retail dining shops in the system, the driver may connect to network provided by these facilities to transmit its status to Edge_Cloud. He may also charge the gas/electricity if it is necessary.

Each vehicle is equipped with a device, which includes a battery that is independent from the standard battery of the vehicle. The battery in the device may be charged and provide power to this device when the vehicle engine is not started. The device may perform the task of transmitting and receiving data with Edge_Cloud for updating status.

Edge_Cloud and Asteroid_Clump gather information (the data above) and calculate supply-demand situation based on vehicle status and user demand.

Surplus=Supply−Demand

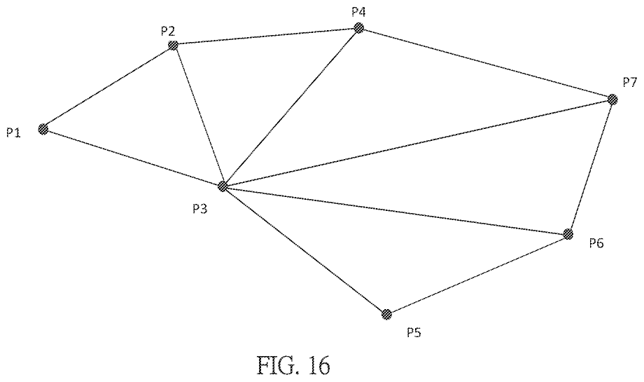

Shown on FIG. 16, based on vehicle location information and supply-demand situation, Asteroid_Clump_on_Duty dynamically update the excess/deficient situation of each location to Edge_Cloud.

In an embodiment of the present disclosure, vehicle information is updated to Edge_Cloud periodically. Asteroid_Clump_on_Duty and Edge_Cloud dynamically calculate and process the excess/deficient situation.

For example, if there are 300 models of vehicles in total. For each model, the dynamic vehicle location is updated continuously. The amount of each model of vehicle in each cell in the figure is calculated at Time_1. Asteroid_Clump_on_Duty and Edge_Cloud would dynamic forecast the amount of each model of vehicle in each cell at a future time Time_2 based on the planned route, dynamic driving status of each vehicle, and the surplus vertex map.

All vehicle may obtain excess/deficient situation of nearby location from Edge_Cloud. All vehicles in the system are also considered as Meteoroid_Clumps that may perform verification, validation, validation check. Occurrence data may be processed by Edge_Cloud, Meteoroid_Clumps (the machines in gas stations, grocery shops), Meteoroid_Clumps (user devices).

An occurrence is initialed when there is a demand of vehicle, and the Edge_Cloud starts to process the demand to find appropriate driver and arrange the route. The occurrence keeps going until the vehicle is driven from one location to the other destination location and is returned to the designated spot.

In an embodiment of the present disclosure, occurrence data to be processed to the globule of AGR system comprise the following:
Pick up Time/Location
Return Time/Location
Member ID of picking up
Member ID of return
Vehicle Model and Identification number
Insurance Information
Passenger Information
Routing Information

In an embodiment of the present disclosure, the data placed in Prills of AGR system (for low-impact occurrence) comprise more detail information, such as the following: (The occurrence data placed in prills will be cosilitated into globule of Satellite_Globule_Cluster in AGR system.)
Pick up Time/Location
Return Time/Location
Member ID of picking up
Member ID of return
Vehicle Model and Identification number
component registration information of major components of this vehicle
Vehicle picture 2D/3D
Insurance Information
Passenger Information
Routing Information
GPS data during trip

In an embodiment of the present disclosure, for the transportation application of this system, the impact is evaluated by the occurrence value equivalent to gold-equivalent in an occurrence. The impact of transportation application may comprise the urgency of the vehicle demand, the sumup of energy saving, the combination of time efficiency and energy reduction of routing arrangement. For an example of high impact, to fulfill an urgent demand of vehicle, with the best arrangement/match of driver and vehicle, the time efficiency and energy reduction of the transpotation of vehicle and driver is maximized, this occurrence may be placed in Cardinal_Globule_Cluster.

How to reduce energy consumption: (These actions are reward with AGR_tally.)
Sharing with more passengers (also get reward from shared passenger)
Best routing with lowest estimated energy(gas/electric) consumption
Good driving habit: reduce sudden acceleration and sudden break

### DETAILED DESCRIPTION OF THE DRAWINGS

### System Operation of Embodiments

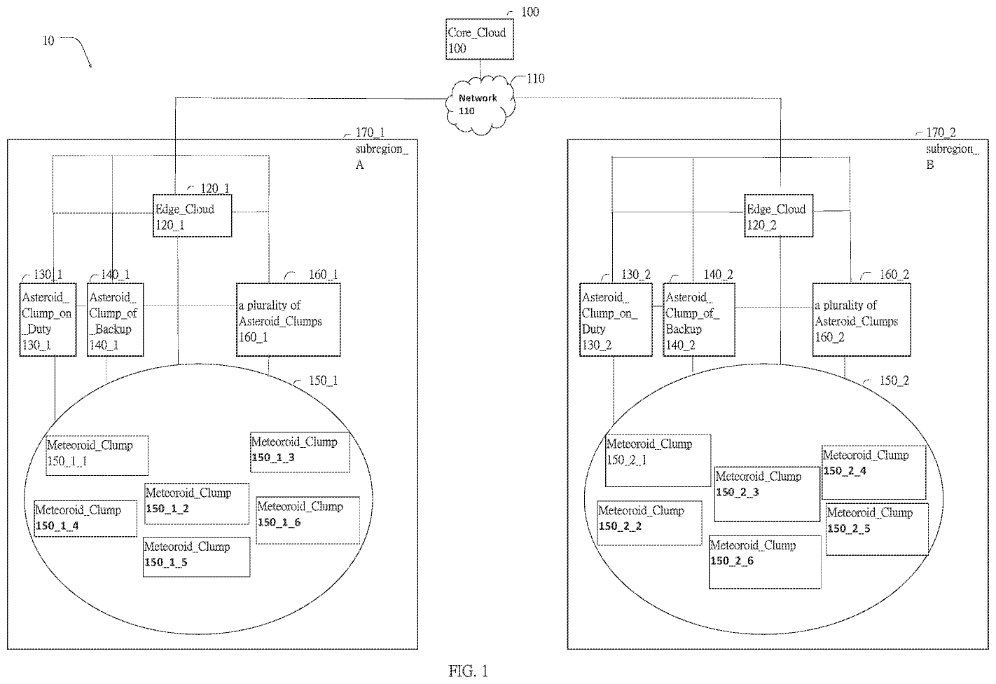

FIG. 1 is a schematic diagram of a system 10 for collaboratively processing occurrences of events according to an embodiment of the present disclosure. In an embodiment of the present disclosure, the system 10 may comprise a Core_Cloud 100, a network 110, at least one Edge_Cloud 120_1-120_2, at least one Asteroid_Clump_on_Duty (ACOD) 130_1-130_2, at least one Asteroid_Clump_of_Backup (ACB) 140_1˜140_2, at least one group of Meteoroid_Clumps (MC) 150_1˜150_2, and at least a plurality of Asteroid_Clumps 160_1˜160_2, wherein the group of Meteoroid_Clump 150_1 comprises Meteoroid_Clump 150_1_1-6 and the group of Meteoroid_Clump 150_2 comprises Meteoroid_Clumps 150_2_1-6. Core_Cloud 100, at least one Edge_Cloud 120_1-120_2, at least one Asteroid_Clump_on_Duty 130_1-130_2, at least one Asteroid_Clump_of_Backup 140_1-140_2, at least one group of Meteoroid_Clumps 150_1-150_2, and at least one plurality of Asteroid_Clumps 160_1˜160_2, are all connected to the network 110 for network data transmission.

In addition, Edge_Cloud 120_1, Asteroid_Clump_on_Duty 130_1, Asteroid_Clump_of_Backup 140_1, the group of Meteoroid_Clump 150_1, and a plurality of Asteroid_Clump 160_1 can be connected to each other and located in subregion 170_1. Edge_Cloud 120_2, Asteroid_Clump_on_Duty 130_2, Asteroid_Clump_of_Backup 140_2, the group of Meteoroid_Clump 150_2, and a plurality of Asteroid_Clumps 160_2 may be connected to each other and located in subregion 170_2. It should be noted that, for the convenience of description, the system 10 in FIG. 1 only shows a part of Edge_Clouds, Asteroid_Clump_on_Dutys, Asteroid_Clump_of_Backups, groups of Meteoroid_Clump, and a plurality of Asteroid_Clump s and subregions. The system 10 may comprise more Edge_Clouds, Asteroid_Clump_on_Dutys, Asteroid_Clump_of_Backups, groups of Meteoroid_Clump, and a plurality of Asteroid_Clumps and subregions.

Specifically, the Core_Cloud 100 is used to process the core computing and storage of the system 10. Edge_Cloud 120_1 (or 120_2) is used to execute the edge computation of the sub-region (for example, locally) and to store the occurrences of the sub-region. Asteroid_Clump_on_Duty 130_1 (or 130_2), Asteroid_Clump_of_Backup 140_1 (or 140_2) or a plurality of Asteroid_Clump 160_1 (or 160_2) can be used to support Edge_Cloud 120_1 (or 120_2) operations. The system operation is supported by organizations participating in system 10. Organizations or institutions include universities, research centers, companies, multinational corporations (such as Starbucks or KFC, etc.), medical centers, but are not limited thereto.

The Asteroid_Clump_on_Duty 130_1 (or 130_2), the Asteroid_Clump_of_Backup 140_1 (or 140_2) or a plurality of Asteroid_Clumps 160_1 (or 160_2) can be a server (or connect to the server through the network 110 at Point of Sale (POS) system, with high computing power and high storage capacity. Meteoroid_Clumps 150_1_1˜6 (or 150_2_1˜6) can be operated by members of the registration system 10, and members can include school personnel (such as students, teaching staff, researchers), medical personnel (such as doctors or nurses) or corporate personnel (such as employees), etc. The Meteoroid_Clumps 150_1_1-6 (or 150_2_1-6) can be personal computers, tablet computers, workstations, or any mobile device capable of performing computing tasks.

In addition, Asteroid_Clump_on_Duty 130_1 (or 130_2) can carry out the primary duty. In the first stage, the initial operation of the system, the number of occurrences is not large, and the number of Asteroid_Clumps participating in the system 10 is not large. There are Asteroid_Clump_on_Duty 130_1 (or 130_2), Asteroid_Clump_of_Backup 140_1 (or 140_2) and a plurality of Asteroid_Clumps 160_1 (or 160_2) in each region.

In the second stage, the system has been running for a while, the number of occurrences has increased. If there is only one Asteroid_Clump_on_Duty 130_1 (or 130_2) per region, the loading of Asteroid_Clump_on_Duty would be too heavy. Therefore, each region has many subregions. There is a processing center in a subregion. There are Asteroid_Clump_on_Duty 130_1 (or 130_2), Asteroid_Clump_of_Backup 140_1 (or 140_2) and a plurality of Asteroid_Clump 160_1 (or 160_2) in each subregion. There are two functions to Asteroid_Clump_of_Backup 140_1 (or 140_2), one is to perform secondary tasks, and the other is when the Asteroid_Clump_on_Duty 130_1 (or 130_2) has an issue (such as abnormal network connection, insufficient memory, or the machine is suspended; the machine fails), it will immediately take over and process all the computing tasks of the Asteroid_Clump_on_Duty 130_1 (or 130_2).

The first stage can be considered as a temporary transition stage, in the first stage, the selection of Asteroid_Clump_on_Duty 130_1 (or 130_2) and Asteroid_Clump_of_Backup 140_1 (or 140_2) in each region is round-robin, and are selected by the committee. Each Asteroid_Clump selected by the committee shall take turns (for example, every month) to perform tasks on Asteroid_Clump_on_Duty 130_1 (or 130_2) or to Asteroid_Clump_of_Backup 140_1 (or 140_2). After selection, the IP addresses of Asteroid_Clump_on_Duty 130_1 (or 130_2) and Asteroid_Clump_of_Backup 140_1 (or 140_2) are broadcast to all clumps in all regions. Accordingly, all clumps know that which clump is Asteroid_Clump_on_Duty 130_1 (or 130_2) and which clump is Asteroid_Clump_of_Backup 140_1 (or 140_2).

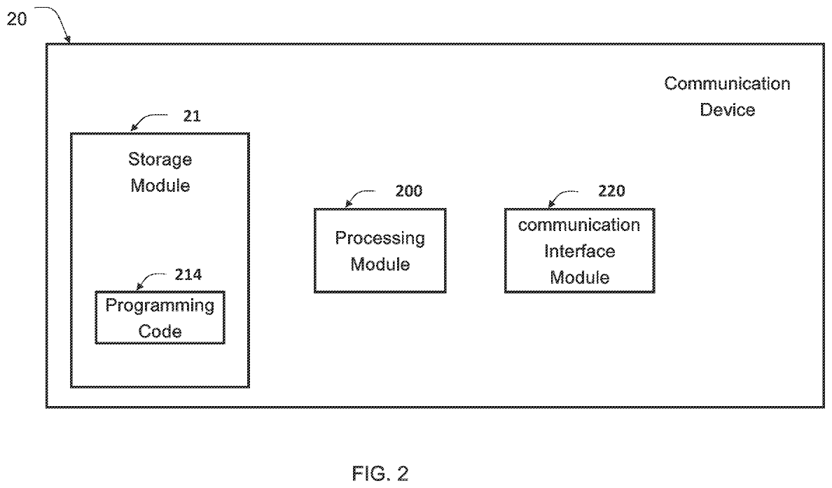

FIG. 2 is a schematic diagram of a communication device 20 according to an embodiment of the present disclosure. The communication device 20 can be the Core_Cloud 100 in FIG. 1, at least one Asteroid_Clump_on_Duty Asteroid_Clump 130_1-130_2 and at least one Asteroid_Clump_of_Backup 140_1-140_2, at least Meteoroid_Clumps 150_1_1-6 (or 150_2_1-6) in the groups of Meteoroid_Clumps 150_1-150_2, or a plurality of Asteroid_Clumps 160_1 (or 160_2), but not limited thereto. The communication device 20 may comprise a processing module 200, a storage module 210 and a communication interface module 220. The processing module 200 may be a microprocessor or an Application-Specific Integrated Circuit (ASIC). The storage module 210 can be any kind of data storage device for storing a program code 214, system data and application program data. For example, the storage module 210 can be a subscriber identity module (Subscriber Identity Module, SIM), a read-only memory (Read-Only Memory, ROM), a flash memory (flash memory), a random access memory (Random-Access Memory, RAM), hard disk (hard disk), etc., but not limited to this.

The processing module 200 can read and execute the program code 214 through the storage module 210. The processing module 200 can process system (such as the system 10) data, application program (such as the application program in the system 10) data and network transmission data. The communication interface module 220 can be a wired or wireless transceiver, which is used to transmit and receive signals (such as data, signals, messages or packets) according to the processing results of the processing module 200. The communication device 20 may further comprise an authentication module for confirming the authenticity or legitimacy of other communication devices. The communication device 20 may further comprise an input/output module for inputting and outputting signals (such as data, signals, messages or packets). The communication device 20 may further comprise a display module for displaying the processing result of the processing module 200.

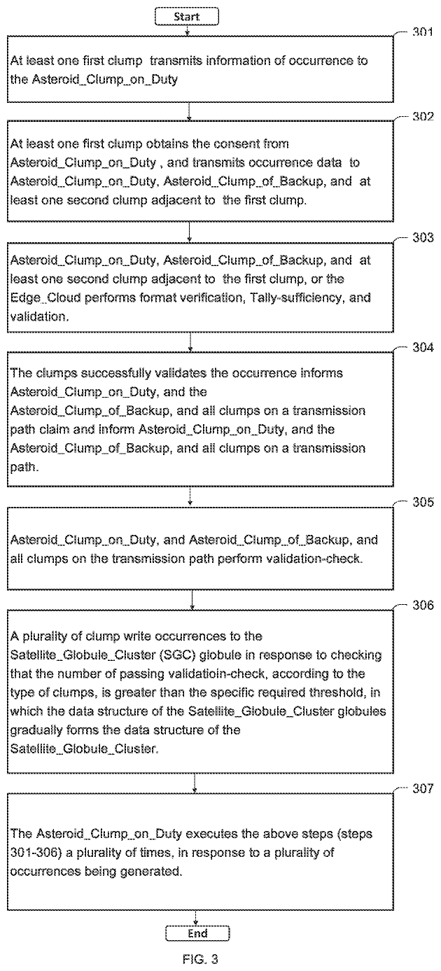

FIG. 3 is a flow chart of a process 30 according to an embodiment of the present disclosure. The process 30 can be used for Edge_Cloud 120_1 (or 120_2) of the system 10 and a plurality of clumps (Asteroid_Clump_on_Duty 130_1 (or 130_2), Asteroid_Clump_of_Backup 140_1 (or 140_2), Meteoroid_Clumps 150_1_1˜6 (or 150_2_1˜6), and a plurality of Asteroid_Clumps 160_1 (or 160_2), which are used to coordinate and cooperate to deal with the occurrences, wherein at least one of clumps produces the occurrences. The process 30 can be compiled into a program code 214, which comprises the following steps:

Step 300: start.

Step 301: At least one first clump (e.g., Meteoroid_Clump 150_1_1 (or 150_2_1) transmits information of occurrence to the Asteroid_Clump_on_Duty 130_1 (or 130_2).

Step 302: At least one first clump obtains the consent from Asteroid_Clump_on_Duty 130_1 (or 130_2), and transmits transmits occurrence data to Asteroid_Clump_on_Duty 130_1 (or 130_2), Asteroid_Clump_of_Backup 140_1 (or 140_2) and at least one second clump (e.g., Meteoroid_Clumps 150_1_2, 150_1_4, 150_2_2, 150_2_4) nearby the first clump.

Step 303: At least one of Asteroid_Clump_on_Duty 130_1 (or 130_2), Asteroid_Clump_of_Backup 140_1 (or 140_2), at least one second clump or Edge_Cloud 120_1 (or 120_2) performs format verification, Tally-sufficiency and validation of occurrence.

Step 304: Asteroid_Clump_on_Duty 130_1 (or 130_2), Asteroid_Clump_of_Backup 140_1 (or 140_2), a plurality of Asteroid_Clump 160_1 (or 160_2) and at least one second clump perform the validation. Each clumps that perform the validation successfully claims and sends message to the Asteroid_Clump_on_Duty 130_1 (or 130_2), Asteroid_Clump_of_Backup 140_1 (or 140_2) and all clumps on the transmission path.

Step 305: Asteroid_Clump_on_Duty 130_1 (or 130_2), Asteroid_Clump_of_Backup 140_1 (or 140_2) and all clump on the transmission path perform validation-check.

Step 306: A plurality of clumps write occurrences to the Satellite_Globule_Cluster (SGC) globule in response to checking that the number of passing validatioin-check, according to the type of clump, is greater than the specific required threshold (requirement fulfilled). In which the data structure of the Satellite_Globule_Cluster globules gradually forms the data structure of the Satellite_Globule_Cluster.

Step 307: The Asteroid_Clump_on_Duty 130_1 (or 130_2) performs the above steps (steps 301˜306) a plurality of times, in response to, respectively, a plurality of occurrences being generated.

Step 308: end.

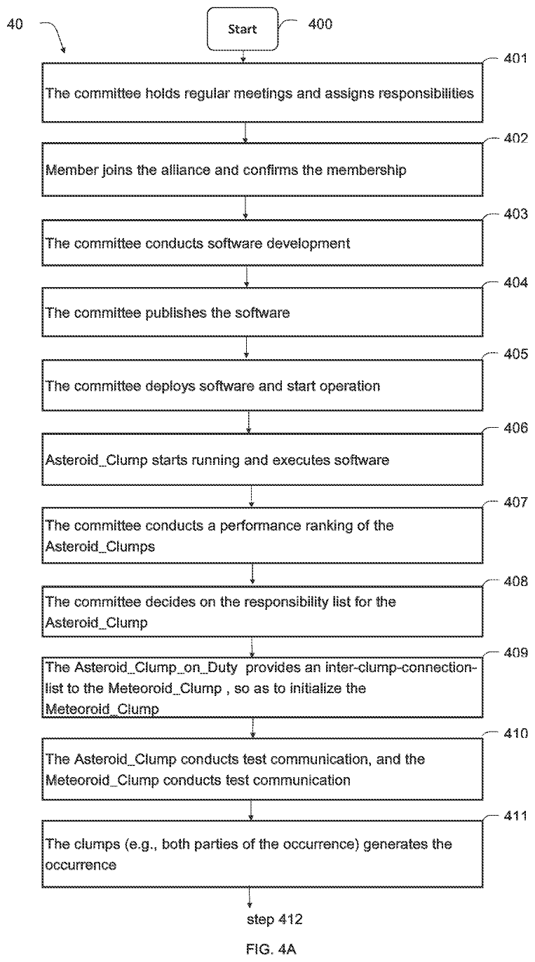

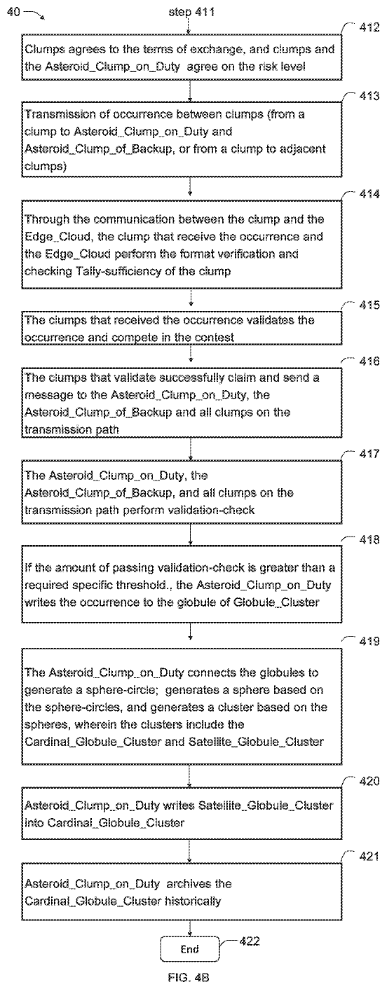

FIG. 4A is a flowchart of a process 40 according to an embodiment of the present disclosure. The process 40 can be used in the system 10 and the process 30. The process 40 can be compiled into a program code 214, which comprises the following steps:

Step 400: Start.

Step 401: The committee holds regular meetings and assigns responsibilities.

Step 402: Member joins the alliance and confirms the membership.

Step 403: The committee conducts software development.

Step 404: The committee publishes the software.

Step 405: The committee deploys software and start operation.

Step 406: Asteroid_Clump starts running and executes software.

Step 407: The committee conducts a performance ranking of the Asteroid_Clumps.

Step 408: The committee determines the responsibility list for the Asteroid_Clump.

Step 409: The Asteroid_Clump_on_Duty 130_1 (or 130_2) provides an inter-clump-connection-list to the Meteoroid_Clump 150_1_1˜6 (or 150_2_1˜6), so as to initialize the Meteoroid_Clump 150_1_1˜6 (or 150_2_1˜6).

Step 410: The Asteroid_Clump conducts test communication, and the Meteoroid_Clump 150_1_1-6 (or 150_2_1-6) conducts test communication.

Step 411: The clumps (e.g., both parties of the occurrence) generates the occurrence.

FIG. 4B is a flow chart of a process 40 according to an embodiment of the present disclosure, which continued step 411 in FIG. 4A and comprises the following steps:

Step 412: Clumps agrees to the terms of exchange, and clumps and the Asteroid_Clump_on_Duty 130_1 (or 130_2) agree on the impact level.

Step 413: Transmission of occurrence between clumps (e.g., from a clump to Asteroid_Clump_on_Duty 130_1 (or 130_2) and Asteroid_Clump_of_Backup 140_1 (or 140_2), or from a clump to adjacent clumps).

Step 414: Through the communication between the clump and Edge_Cloud, the clump that receive the occurrence and Edge_Cloud perform the format verification and check Tally-sufficiency of the clump.

Step 415: The clumps that received the occurrence validates the occurrence and compete in the contest.

Step 416: The clumps that validate successfully claim and send a message to the Asteroid_Clump_on_Duty 130_1 (or 130_2), the Asteroid_Clump_of_Backup 140_1 (or 140_2) and all clumps on the transmission path.

Step 417: The Asteroid_Clump_on_Duty 130_1 (or 130_2), the Asteroid_Clump_of_Backup 140_1 (or 140_2) and all clumps on the transmission path perform validation-check.

Step 418: If the amount of passing validation-check is greater than a specific required threshold (based on the type of the clump), the Asteroid_Clump_on_Duty 130_1 (or 130_2) writes the occurrence to the globule of Globule_Cluster.

Step 419: The Asteroid_Clump_on_Duty 130_1 (or 130_2) connects the globules to generate a sphere-circle; generates a sphere based on the sphere-circles, and generates a cluster based on the spheres, wherein the clusters comprise the Cardinal_Globule_Cluster and Satellite_Globule_Cluster.

Step 420: Asteroid_Clump_on_Duty 130_1 (or 130_2) writes Satellite_Globule_Cluster into Cardinal_Globule_Cluster.

Step 421: Asteroid_Clump_on_Duty 130_1 (or 130_2) archives the Cardinal_Globule_Cluster historically.

Step 422: end.

The implementation of the processes 30 and 40 is not limited to the above, and the following embodiments can be applied to implement the processes 30 and 40.

In one embodiment, at least one first clump (or the clump that generated the occurrence) transmits the occurrence based on different impact levels (e.g., high impact, medium impact, or low impact). In one embodiment, at least one first clump may comprise a sender of occurrences and a receiver of occurrences.

When the impact level is high impact, at least one first clump (or the clump that generated the occurrence) transmits the occurrence to the Asteroid_Clump_on_Duty and Asteroid_Clump_of_Backup in the region registered by the sender, and at least one first clump (or clumps that generate occurrences) also transmit occurrences to Asteroid_Clump_on_Duty and Asteroid_Clump_of_Backup in the region where the receiver is registered. In addition, at least one first clump (or clumps generating the occurrence) transmits the occurrence to the following clumps:
a predetermined number (such as at least 20, but not limited to this) of Asteroid_Clump in the region registered by the sender,
a predetermined number Asteroid_Clump (such as at least 20, but not limited to this) in the region registered by the receiver,
a predetermined number (such as at least 90, but not limited to this) of Meteoroid_Clump on the list in the region registered by the sender,
a predetermined number (such as, at least 90, but not limited to this) of Meteoroid_Clump on the list in the region registered by the receiver.

The two registration regions refer to the region of the institution that the Sender_of_Occurrence registers from, and the region of the institution that the Receiver_of_Occurrence registers from.

When the impact level is medium impact, at least one first clump (or the clump that generates the occurrence) transmits the information of occurrence to Asteroid_Clump_on_Duty and Asteroid_Clump_of_Backup in the region where the sender is located; at least one first clump (or the clump that generates the occurrence) also transmits the information of occurrence to Asteroid_Clump_on_Duty and Asteroid_Clump_of_Backup in the region where the receiver is located. The region where the sender is located refers to the physical location of the sender. The region where the receiver is located refers to the physical location of the receiver.

In addition, at least one first clump (or clumps generating the occurrence) transmits the occurrence to the following clumps:
a predetermined number (such as at least 10, but not limited to this) of Asteroid_Clump in the region where the sender is located,
a predetermined number (such as at least 10, but not limited to this) of Asteroid_Clump in the region where the receiver is located,
a predetermined number (such as at least 60, but not limited to this) of Meteoroid_Clump on the list in the region where the receiver is located.

When the impact level is low impact, at least one first clump (or the clump that generates the occurrence) transmits the information of occurrence to Asteroid_Clump_on_Duty and Asteroid_Clump_of_Backup in the region where the sender is located; at least one first clump (or the clump that generates the occurrence) also transmits the information of occurrence to Asteroid_Clump_on_Duty and Asteroid_Clump_of_Backup in the region where the receiver is located.

In addition, at least one first clump (or clumps generating the occurrence) transmits the occurrence to the following clumps:
a predetermined number (such as at least 2, but not limited to this) of Asteroid_Clump in the region where the sender is located,
a predetermined number (such as at least 2, but not limited to this) of Asteroid_Clump in the region where the receiver is located,
a predetermined number (such as at least 30, but not limited to this) of Meteoroid_Clump on the list in the region where the receiver is located.

If Sender_of_Occurrence and Receiver_of_Occurrence are located at the same region, the amount of Asteroid_Clump to transmit occurrence is two. If Sender_of_Occurrence and Receiver_of_Occurrence are located at different region, the amount of Asteroid_Clump to transmit occurrence is four.

If not getting validation from Asteroid_Clump_on_Duty at Receiver_of_Occurrence region, it is OK to get validation from Asteroid_Clumps other than Asteroid_Clump_on_Duty. There are x Asteroid_Clumps validating this occurrence successfully. For example, the total amount of Asteroid_Clumps that validate the occurrence successfully equals x. (The validation from Asteroid_Clump_on_Duty at Receiver_of_Occurrence region is included.)

It may also get validation from y Meteoroid_Clumps (The number of Meteoroid_Clumps that validate the occurrence successfully equals y).

This is an example of requirement of number of successful validation of an embodiment:

The total number of Meteoroid_Clumps that validate the occurrence successfully is at least two. (That is: x+y>=2)
where x>=1 (at least one of the successful validation is from Asteroid_Clump)

For instance, the following scenarios are OK:
Validation Asteroid_Clump_on_Duty=1, Validation Meteoroid_Clump=1;
Validation Asteroid_Clump_on_Duty=1,
Validation Asteroid_Clump(other than ACOD ACB)=1;
Validation Asteroid_Clump(other than ACOD ACB)=1, Validation Meteoroid_Clump=1;
The globule of the occurrences is validated when the requirement shown above is fulfilled.

In an embodiment, the transmission of occurrences between clusters may include two processes flows. The first processes flow is used for high-impact and medium-impact occurrences, and the second processes flow is used for low-impact occurrences. In a first processes flow, the Asteroid_Clump_on_Duty places the occurrence data in the cloud's queue area. Each clump may receive the information of occurrences from either the cloud's queue region or from a clump, such as Meteoroid_Clump 150_1_1 (or 150_2_1).

In the second process, each cluster may receive information about occurrence from a clump (such as Meteoroid_Clump 150_1_1 (or 150_2_1)). Compared with high-impact occurrences and medium-impact occurrences, the hardness requirement for low-impact occurrences is lower. Besides, the hardness requirement of Satellite_Globule_Cluster competing in the contest of writing to Cardinal_Globule_Cluster is less than the hardness requirement of regular validation by clumps in Cardinal_Globule_Cluster.

Edge_Cloud 120_1 (or 120_2) is connected to the Core_Cloud 100. In an embodiment, the Asteroid_Clump_on_Duty 130_1 (or 130_2) performs the above-mentioned operations multiple times, until the amount of the Satellite_Globule_Cluster data and the amount of another Satellite_Globule_Cluster data is greater than a specific required threshold. The Asteroid_Clump_on_Duty 130_1 (or 130_2) conducts the contest of validation among at least two Satellite_Globule_Cluster data structure, and the winner in the contest of the Satellite_Globule_Cluster data structure is written to a Cardinal_Globule_Cluster data structure. In an embodiment, the specific threshold is predetermined (e.g., by a committee).

In an embodiment, the Cardinal_Globule_Cluster data structure comprises a plurality of Cardinal_Globule_Cluster sphere data structure; wherein the Cardinal_Globule_Cluster sphere data structure comprise a plurality of Cardinal_Globule_Cluster globule data structure.

In an embodiment, the Cardinal_Globule_Cluster globule data structure within the Cardinal_Globule_Cluster sphere data structure comprise a hash computation result of globule_conspectus of a plurality of previous Cardinal_Globule_Cluster globule data structure within the Cardinal_Globule_Cluster sphere data structure.

In an embodiment, the globule index value of Cardinal_Globule_Cluster globule data structure within the Cardinal_Globule_Cluster sphere data structure is the same globule index value of Cardinal_Globule_Cluster globule data structure of a plurality of previous the Cardinal_Globule_Cluster sphere data structure.

In an embodiment, a plurality of Satellite_Globule_Cluster globule data structure form Satellite_Globule_Cluster sphere circle data structure; a plurality of Satellite_Globule_Cluster sphere_circle data structure form Satellite_Globule_Cluster sphere data structure; a plurality of Satellite_Globule_Cluster sphere data structure form Satellite_Globule_Cluster data structure.

In an embodiment, the Asteroid_Clump_on_Duty 130_1 (or 130_2 is predetermined by the system based on one of these criteria: physical location or network proximity; historical credit; regular review by the system committee.

In an embodiment, the occurrence of event comprises a service exchange; and the service exchange comprise a stuff exchange, a privilege exchange, or a knowledge exchange.

In an embodiment, the historical credit of a clump is determined by the duration of time that the tally has been kept by the clump.

The historical credit may be collected from the cloud. The historical credit of a clump is the weighted sum of these four factors and these are calculated by Asteroid_Clump_of_Backup:
the amount of successful validation done by the clump (it is written on the globule)
the amount of correct computation but not fast enough that the clump claims to Asteroid_Clump_of_Backup
the amount of almost-there validation done by the clump (almost reaching the requirement of validation)
the duration of time that tally has been kept by the clump

In an embodiment, after format verification and Tally_sufficiency check are confirmed, the Asteroid_Clump_on_Duty 130_1 (or 130_2), the Asteroid_Clump_of_Backup 140_1 (or 140_2), a plurality of Asteroid_Clumps 160_1 (or 160_2), at least one of the second clumps performs validation. The first clump can send a request to Edge_Cloud 120_1 (or 120_2) for Tally_sufficiency check, and the system 10 can perform the Tally_sufficiency check, and respond to whether the remaining tally of a clump is sufficient for this occurrence. The cloud can be jointly managed by the system committee and all Asteroid_Clump_on_Duty.

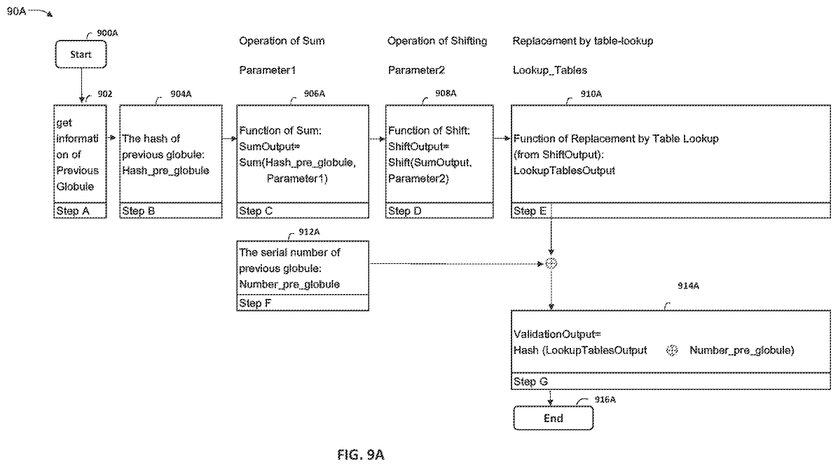

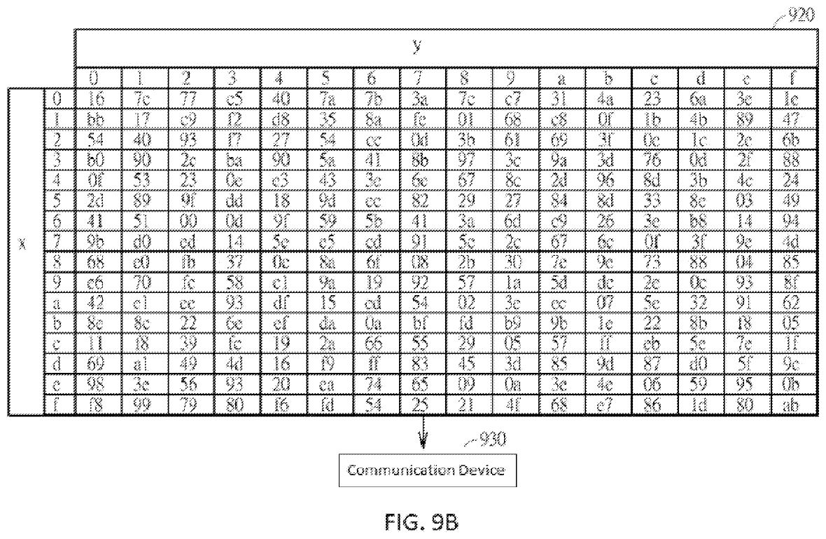

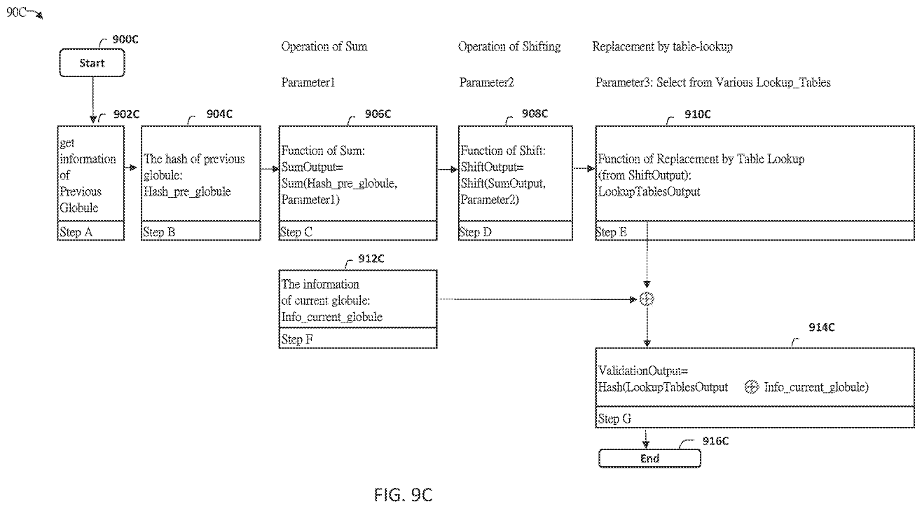

In an embodiment, shown in FIG. 9A, the operation of occurrence validation comprises:
obtaining information from previous globule, by a clump, and executing a hash operation; and
choosing a parameter one, by the clump, and executing summing operation of the hash of previous globule and parameter one; and
choosing a parameter two, by the clump, and executing shifting operation of the result of summing operation in previous step by a digit of parameter two; and
executing, by the clump, a table-lookup operation from the result of shifting operation of previous step; and
executing, by the clump, a XOR operation to get a validation output from the result of table-lookup operation of previous step and a serial number of previous globule.

In another embodiment, shown in FIG. 9C, the operation of occurrence validation comprises:
obtaining information from previous globule, by a clump, and executing a hash operation; and
choosing a parameter one, by the clump, and executing summing operation of the hash of previous globule and parameter one; and
choosing a parameter two, by the clump, and executing shifting operation of the result of summing operation in previous step by a digit of parameter two; and
executing, by the clump, a table-lookup operation from the result of shifting operation of previous step; and
executing, by the clump, a XOR operation to get a validation output from the result of table-lookup operation of previous step and the data of some columns in globule constituent of current globule.

In an embodiment, the information includes impact level and the condition for exchange. At least one first clump determines the impact level. For an accommodation/dining/retail embodiment, if the occurrence is not in the All-Impact-Low store, it is required to obtain an endorsement for the Asteroid_Clump_on_Duty.

In an embodiment, globule_conspectus and globule constituent of the occurrence are written to the globule of Cardinal_Globule_Cluster or the globule of Satellite_Globule_Cluster, after the amount of passing validation-check based on the type of the clump is greater than the specific required threshold; wherein the required threshold is predetermined.

The above-mentioned globule, sphere_circle, sphere, and cluster are all data structures. The cluster contains spheres; the sphere contains sphere_circles; and the sphere_circle contains globules.

FIG. 5 is a schematic diagram 50 of all clumps transmission occurrences on the transmission path according to an embodiment of the present disclosure, which can be used in the system 10 and can be used to transmit occurrences to Meteoroid_Clumps when the impact level of the occurrence is low impact. A Core_Cloud 51, an Edge_Cloud 52, an Asteroid_Clump_on_Duty 53, an Asteroid_Clump_of_Backup 54, a group of Meteoroid_Clump 55, a first ring of Meteoroid_Clumps 55_1, a second ring of Meteoroid_Clumps 55_2, a third ring of Meteoroid_Clumps 55_3, a fourth ring of Meteoroid_Clumps 55_4, a fifth ring of Meteoroid_Clumps 55_5, and the connection between them are shown in FIG. 5. The flowchart 50 can be compiled into a program code 214, which includes the following steps

Step 500: Core_Cloud 51 deploys system software on Edge_Cloud 52.

Step 502: Edge_Cloud 52 periodically updates the consolidated local information to Core_Cloud 51.

Step 504: The Meteoroid_Clump 55 periodically checks with Edge_Cloud 52 whether there is a new version of the software.

Step 506: The Meteoroid_Clump 55 obtains the new software from Edge_Cloud 52 and updates the software.

Step 508: Edge_Cloud 52 periodically obtains the duration of time that tally has been kept by the clump, and Asteroid_Clump_of_Backup 54 to calculate the historical credit of the clump.

Step 510: The Meteoroid_Clump 55 requests Edge_Cloud 52 to provide historical credits of the clumps (for example, all Meteoroid_Clumps in FIG. 5).

Step 512: Edge_Cloud 52 provides historical credits of the clumps to the Meteoroid_Clump 55.

Step 514: After excluding Meteoroid_Clumps with poor response rate (NOT-GOOD) on the list of Meteoroid_Clump, according to the network capability, hash power and historical credit of the clump, the Meteoroid_Clump 55 transmits the occurrence to the first ring Meteoroid_Clumps 55_1 (for example, the Meteoroid_Clump pointed by the arrow, where the Meteoroid_Clump with poor response, poor network capability, poor hash power, and poor historical credit of the clump has been excluded).

Step 516: After excluding Meteoroid_Clump with poor response, poor network capability, poor hash power, and poor historical credit of the clump, the first ring Meteoroid_Clumps 55_1 transmits the occurrence to the second ring Meteoroid_Clumps 55_2.

Step 518: After excluding Meteoroid_Clump with poor response, poor network capability, poor hash power, and poor historical credit of the clump, the second ring Meteoroid_Clumps 55_2 transmits the occurrence to the third ring Meteoroid_Clumps 55_3.

After excluding Meteoroid_Clump with poor response, poor network capability, poor hash power, and poor historical credit of the clump, the third ring Meteoroid_Clumps 55_3 transmits the occurrence to the fourth ring Meteoroid_Clumps 55_4. After excluding Meteoroid_Clump with poor response, poor network capability, poor hash power, and poor historical credit of the clump, the fourth ring Meteoroid_Clumps 55_4 transmits the occurrence to the fifth ring Meteoroid_Clumps 55_5. In an embodiment, the fifth ring Meteoroid_Clumps 55_5 may stop continuing the transmission to the next ring. How many rings of Meteoroid_Clumps that packets are to be transmitted to is determined by the system committee.

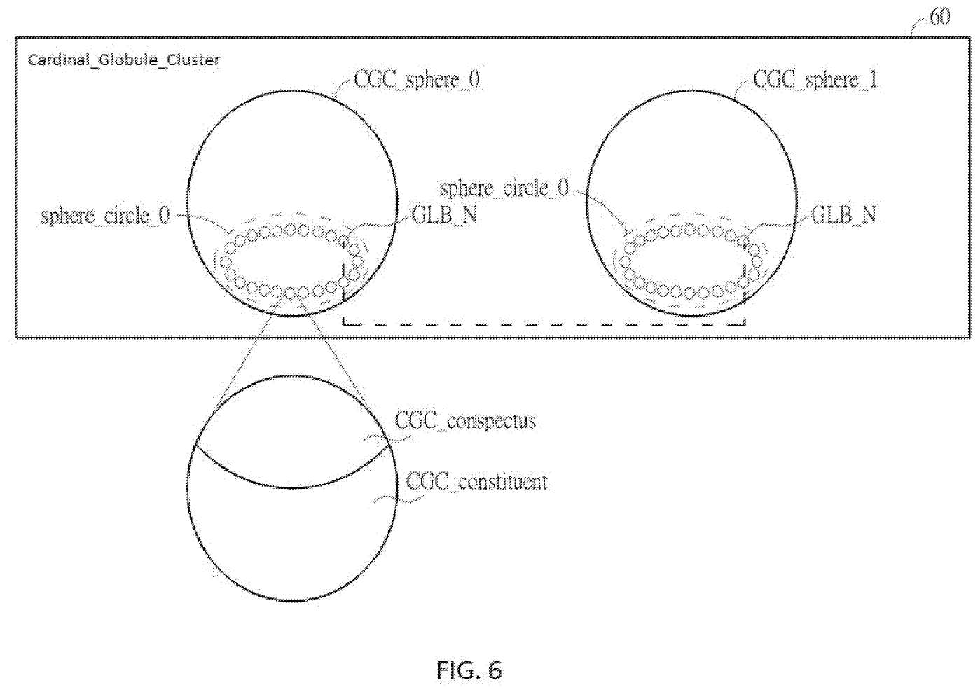

FIG. 6 is a schematic diagram of a Cardinal_Globule_Cluster data structure 60 in an embodiment of the present disclosure, which can be used in the system 10 and the process 30. The Cardinal_Globule_Cluster data structure 60 includes the sphere data structure CGC_sphere_0. The sphere data structure CGC_Sphere_0 includes the sphere_circle data structure sphere_circle_0, and the sphere_circle data structure sphere_circle_0 includes a plurality of globules data structures GLB_1˜N, where N is a positive integer.

Each globule data structure contains a globule constituent (CGC_constituent), which is used to store some important information of an occurrence. Each globule data structure also includes a globule_conspectus (CGC_conspectus), which is used to store the essence of the globule_conspectus and the extract of the globule construction process. In detail, a specific number of occurrences is stored in the globule data structure (e.g., in the globule_constituent) (e.g., at least one entry in the Cardinal_Globule_Cluster; many entries in the Satellite_Globule_Cluster, such as 50 entries, but not limited to this). A clump can extract necessary data from the globule constituent, calculate, and fill the necessary data into the necessary columns in the globule_conspectus.

Necessary data in globule_conspectus may comprise the following columns: (Depending on the application, some columns could be optional.)
serial number of the globule;
the software variant number;
the impact_category;
hash_previous_n_globule: the hash value of the previous multiple globules, (for example, the number is 3, the hash values of globule_conspectus of previous three globules are concatenated and the hash operation is performed);
recap_Hash_PreviousCGCsphere: There is a column in the conspectus of Globule. The column contains the Recap of a Globule in previous sphere of Cardinal_Globule_Cluster (CGC-sphere). Recap contains globule_conspectus (result of hash function of all occurrences in the globule) of globules of previous several spheres. It is the corresponding (for example, with the same index value) recap of a hash of the globule_conspectus in previous one or several spheres of Cardinal_Globule_Cluster. (There is no such recap column in a globule of Satellite_Globule_Cluster.);
the time of the current globule;
time_previous_n_globules: the concatenation string of time of previous several globules;
bits_require_hardness: the hardness level is controlled by the number of bits (for example, the more bits, the higher the hardness);
chosen: the parameter values used by validator that successfully validate a globule;
IP_address_Current: the concatenation of IP address of those validators that successfully validate a globule;
IP_address_Previous_Several_Globule: the concatenation of IP address of those validators that successfully validate previous n globule;
hash_globule_constituent: the root hash of hash tree of globule constituent (all occurrence data in the globule);
priority: the priority to write;

All columns above form globule_conspectus of a globule. It may be concatenated all together (or programmed as a matrix).

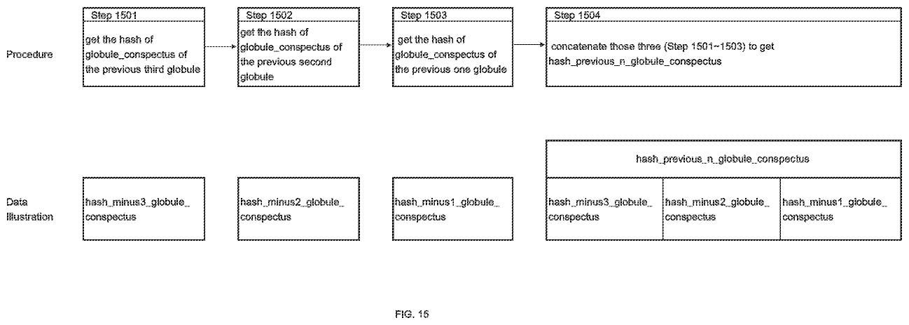

FIG. 15 illustrates an example of column hash_previous_n_globule. If the serial number of current globule is 350th globule.

Step 1501: get the hash of globule_conspectus of the previous third globule (e.g., 347th globule)

Step 1502: get the hash of globule_conspectus of the previous second globule (e.g., 348th globule)

Step 1503: get the hash of globule_conspectus of the previous one globule (e.g., 349th globule)

Step 1504: concatenate those three in previous three steps to get hash_previous_n_globule_conspectus (concatenate 347th globule, 348th globule, 349th globule).

The indexing of the w globule in the z sphere_circle in the y sphere data structure of the x Cardinal_Globule_Cluster contains 4 dimensions. The example data structure may be represented (such as CGC_globule[x][y][z][w]). That is, x refers to which Cardinal_Globule_Cluster data structure; y refers to which sphere in Cardinal_Globule_Cluster; z refers to which sphere_circle in a sphere of Cardinal_Globule_Cluster; w refers to which globule in a sphere_circle of a sphere.

As shown in FIG. 6, the sphere CGC_Sphere_0 is the 0th sphere data structure in the 0th Cardinal_Globule_Cluster; and the sphere_circle_0 is the 0th sphere_circle; and the 9th globule GLB_N can be represented by CGC_globule[0][0][0][9]. The CGC_Sphere_1 is the first sphere in the 0th Cardinal_Globule_Cluster; and the sphere_circle_0 is the 0th sphere_circles. The data structure of the 0th Cardinal_Globule_Cluster, the first sphere, the 0th sphere_circle, and the 9th globule can be represented as CGC_globule[0][1][0][9].

There is a column in the conspectus of Globule. The column contains the Recap of globule_conspectus in previous several spheres of Cardinal_Globule_Cluster (CGC-sphere). For example, for the 18th globule in the second CGC-sphere (globule-17 of CGC-sphere-1), it contains the recap of the globule_conspectus of 18th globule in the first CGC-sphere (globule-17 of CGC-sphere-0). In other word, there is a column in globule-17 of CGC-sphere-1 where the value of the recap of globule-17 of CGC-sphere-0 is placed.

For the first CGC-sphere in the first Cardinal_Globule_Cluster which contains a series of CGC sphere, there is no previous CGC-sphere to refer to. Therefore, the content in the column, recap_Hash_PreviousCGCsphere, in the first CGC-sphere in the first Cardinal_Globule_Cluster would be zero.

It should be noted that, for the convenience of description, the data structure 60 of the Cardinal_Globule_Cluster in FIG. 6 only includes two spheres. In fact, the Cardinal_Globule_Cluster data structure 60 may contain more (for example, more than two) spheres.

For example, there may be three spheres. In this way, the recap_Hash_PreviousCGCsphere of Nth globule in the Qth sphere_circle of the third sphere contains the globule_conspectus of Nth globule in the Qth sphere_circle in the second sphere, and the globule_conspectus of Nth globule in Qth sphere_circle of the first sphere, where Q is a positive integer.

That is, the recap of the globules of the previous several (e.g. two) (how many spheres depending on application) spheres is firmly bonded with the current sphere. As more and more spheres data structures and cluster data structures becoming larger and larger, it becomes more difficult to attach the content of the globule data of occurrence. Therefore, according to the design of the present disclosure, as the data structure of the clusters grows larger, it becomes more difficult for a malicious attacker to tamper with the contents of the globule data.

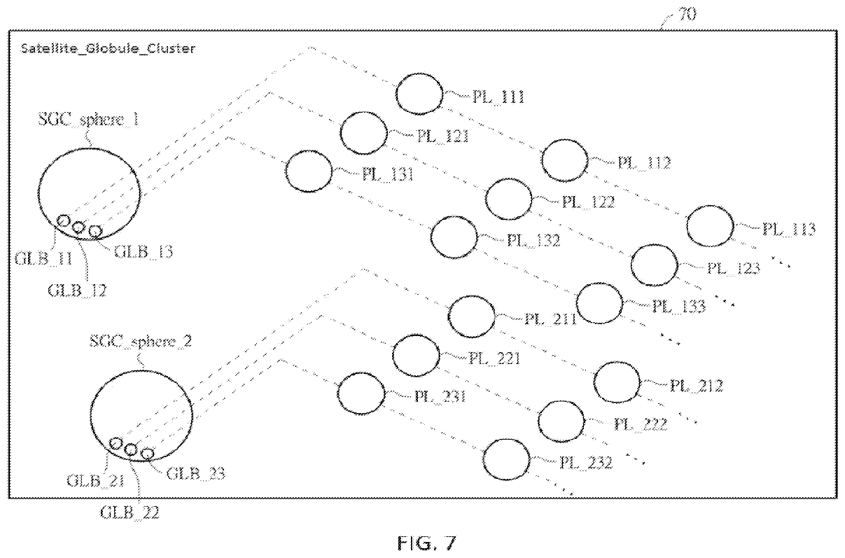

FIG. 7 is a schematic diagram of Satellite_Globule_Cluster 70 in an embodiment of the present disclosure. The diagram can be used in the process 30. The Satellite_Globule_Cluster 70 contains SGC_sphere_1˜2, which are used to store information of occurrences in two different regions. (The figure is only for illustration; there could be more spheres in Satellite_Globule_Cluster.) The sphere SGC_sphere_1 contains a plurality of globules GLB_11˜13, and the sphere SGC_sphere_2 contains a plurality of globules GLB_21˜23. These globules are used to store the occurrences of sub-regions, wherein each globule of GLB_11˜13 contains a plurality of prills PL_1˜M, which is used to store a set of occurrences in the sub-region, where M is a positive integer.

Stage-1 can be considered as a temporary transitional stage. During stage-1, all occurrence data of a region are placed in the globule constituent of SGC-globule to form SGC-sphere. There are many globules within each SGC-sphere. There is a SGC-sphere for each region (during stage-1 and stage-2). There is a SGC-globule (within a SGC-sphere) for each sub-region (during stage-2). There are prills in each sub-region. The prills in each sub-region are detail content of the globule in Satellite_Globule_Cluster. The prills could be considered as data-column stored in Edge_Cloud. Each prill contains one or a set of occurrence. The prills are placed on Edge_Cloud and may be accessed by the clumps in that sub-region in stage-2.

In an embodiment, the Asteroid_Clump_on_Duty in each region or sub-region need to perform the task of Writing to Cardinal_Globule_Cluster from Satellite_Globule_Cluster when the last two number of the globule serial number of Cardinal_Globule_Cluster is getting close to “00” based on the method of validation contest with priority.

There are several Asteroid_Clump_on_Duty (for example, eight Asteroid_Clump_on_Duty). These clumps need to compete to write to Cardinal_Globule_Cluster. The winner of tournament may write the data onto the globule ending with two zero in the globule serial number. All Asteroid_Clump_on_Duty need to report to the system two globules before this globule ending with two zero in the globule serial number. For example, if the globule number ending with zero is 100, right upon the globule of 098 is formed (before the globule of 099 is formed,) all Asteroid_Clump_on_Duty need to report to the system whether they have any data to be written on the Cardinal_Globule_Cluster. If there is no Asteroid_Clump that have data to be written on the Cardinal_Globule_Cluster. This globule ending with two-zero is open for tournament to all clumps in the system.

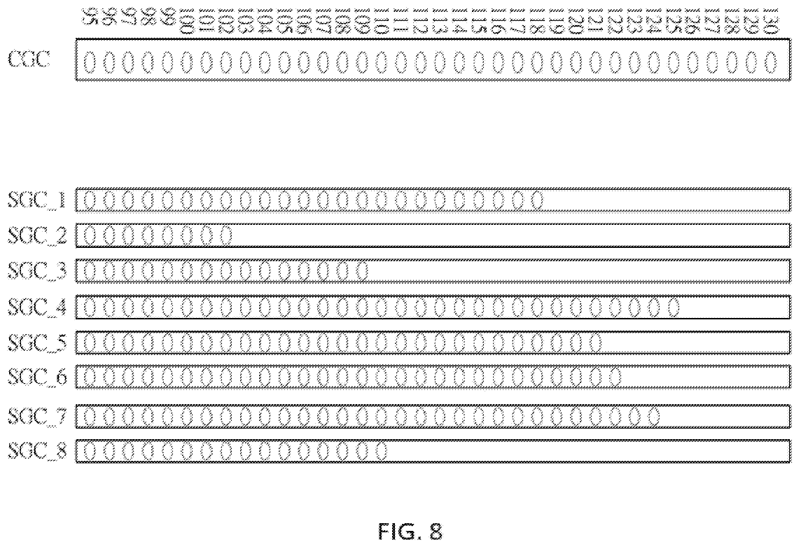

FIG. 8 is a schematic diagram of an embodiment of the present disclosure, where a plurality of Cardinal_Globule_Clusters announce the contest results and record (for example write) in the Cardinal_Globule_Cluster at the same time, which can be used in the process 30. FIG. 8 contains the Satellite_Globule_Cluster SGC_1˜8, the Cardinal_Globule_Cluster CGC, and the CGC comprises globules GLB_95˜130. The Asteroid_Clump_on_Duty 130_1 (or 130_2) in each region 170_1 (or 170_2) must simultaneously record the Satellite_Globule_Cluster SGC_1˜8 it processes in the Cardinal_Globule_Cluster CGC, and the timing of the simultaneous recording is when the last two digits of the serial number of the globule in the Cardinal_Globule_Cluster CGC are “00”,

All Satellite_Globule_Cluster with sufficient occurrence prepare to compete in the contest in order to write the important occurrence data in Satellite_Globule_Cluster onto Cardinal_Globule_Cluster. All Asteroid_Clump_on_Duty 130_1-130_2 must report to the system two globules before the globule of serial number ending with “00” is formed. As shown in FIG. 8, the Asteroid_Clump_on_Duty 130_1 (or 130_2) decides to write the Satellite_Globule_Cluster SGC_1˜8 onto the globule ending with 100 in the Cardinal_Globule_Cluster CGC. While the globule ending with 098 is formed (before the globule ending with 099 is formed), all Asteroid_Clump_on_Duty 130_1˜130_2 must report to the system 10 whether there are any globule data to be written to the Cardinal_Globule_Cluster CGC. If not, globule ending in 100 is open to any clump with Cardinal_Globule_Cluster data to compete for writing.

There is one Asteroid_Clump_on_Duty in each region or sub-region dealing with the Satellite_Globule_Cluster in that region or sub-region. Each Satellite_Globule_Cluster competes based on validation method described in validation process section.

In an embodiment, if one Satellite_Globule_Cluster did not win the contest of tournament successfully for ten times, this Satellite_Globule_Cluster would have priority to write to Cardinal_Globule_Cluster without winning the contest of tournament on the 11th time of tournament that this Satellite_Globule_Cluster participates recently for writing to Cardinal_Globule_Cluster.

For example, if one Satellite_Globule_Cluster did not win the contest of tournament successfully on the globule number 100, 200, 300, 400, 500, 600, 700, 800, 900, 1000 of Cardinal_Globule_Cluster. At the time of 1098 globule is formed, this Asteroid_Clump_on_Duty with this Satellite_Globule_Cluster would inform all Asteroid_Clump_on_Duty in the system that it has Satellite_Globule_Cluster to write to Cardinal_Globule_Cluster but failed for ten times. In an embodiment, there is a priority field in data structure of the validation process. The default value in priority field is zero. The system would reply this Asteroid_Clump_on_Duty to agree this Satellite_Globule_Cluster to change its priority to one if there is no other Satellite_Globule_Cluster in the same situation. This Satellite_Globule_Cluster with priority one would have higher priority in contest.

The priority could be done through the setting of validation. (The method is described in Methods of Validation process section). For example, the standard digit required in Method1 to win the tournament is to reach the target of ValidationOutput with the amount of n_lead of leading F.

In the case of priority one, the digit required in Method1 to win the contest to reach the target of ValidationOutput become the amount of (n_lead-2) of leading F.

For instance,

If the standard n_lead=6, ValidationOutput>=FFFFFF0000000000

6−2=4

The one with priority one only need to get 4 leading F:

ValidationOutput>=FFFF000000000000

FIG. 9A is a flow chart of a process 90 according to the embodiment of the present disclosure, which can be used by all clumps, and is used to implement the process of validation. The system committee decide which the method of the validation based on the characteristic of system application. The method of FIG. 9A is one example, and The method of FIG. 9C is another example. The process 90A can be compiled into program code 214A, which comprises the following steps:

Step 900A: start.

Step 902A: obtaining the information of globule_conspectus from previous globule.

Step 904A: performing a hash operation on the information obtained from the previous globule to generate an operation result.

Step 906A: obtaining information from previous globule, by a clump, and executing a hash operation; and choosing a parameter one, by the clump, and executing summing operation of the hash of previous globule and parameter one.

Step 908A: choosing a parameter two, by the clump, and executing shifting operation of the result of summing operation in previous step by a digit of parameter two.

Step 910A: executing, by the clump, a table-lookup operation from the result of shifting operation of previous step.

Step 912A: obtaining the serial number of the previous globule.

Step 914A: executing, by the clump, a XOR operation to get a validation output from the result of table-lookup operation of previous step and a serial number of previous globule.

Step 916A: end

After format verification, the process 90 is executed. The values of parameter one and parameter two are chosen by a clump. The parameter two is used to determine how the sum should be shifted (e.g., number of bits). A clump can perform process 90 by keeping using different values of parameter one and parameter two. The way of hashing can be decided by the committee. For example, if the committee decided to use Keccak-512 for the system, the number of digits in the hash would be 512.

The following uses a 16-digits hash as an example to illustrate the process 90. In the process 90, it is the parameter two that determines “how many bits to shift the sum”. Base 16 hexadecimal is converted to base 2 binary, bitwise right shifted by the number of bits of parameter two, and the binary number is converted back to base 16 hexadecimal for the table-lookup.

FIG. 9C is a flow chart of a process 90C according to another embodiment of the present disclosure, which can be used by all clumps, and is used to implement the process of validation. It comprises the following steps:

Step 900C: start.

Step 902C: obtaining the information of globule_conspectus from previous globule.

Step 904C: performing a hash operation on the information obtained from the previous globule to generate an operation result.

Step 906C: obtaining information from previous globule, by a clump, and executing a hash operation; and choosing a parameter one, by the clump, and executing summing operation of the hash of previous globule and parameter one.

Step 908C: choosing a parameter two, by the clump, and executing shifting operation of the result of summing operation in previous step by a digit of parameter two.

Step 910C: executing, by the clump, and choosing a parameter three, and executing a table-lookup operation from the result of shifting operation of previous step.

Step 912C: obtaining the information of the current globule. (e.g., some columns in globule constituent)

Step 914C: executing, by the clump, a XOR operation to get a validation output from the result of table-lookup operation of previous step and the data of some columns in globule constituent of current globule.

Step 916C: end

In Step 912C, the system committee decide which information of the current globule based on the characteristic of system application. For example, it may obtain the data of some columns in globule constituent of the current globule. Another example is obtaining the data of globule_conspectus of the current globule. Parameter3 in FIG. 9C is a selection from Various Lookup Tables provided by the system. For example, there are three Lookup Tables provided by the system. The values of Parameter3 could be one, two, or three. A clump may keep trying using one of these three Lookup Tables (along with parameter one and parameter two) to execute process 90C until it reaches a desired result.

### <Method1>

In an example embodiment, Method1 is applied for validation. There is only one Replacement-Table on step 910 that are provided by the system. Different first and second parameters are tried to produce valid verification results. The goal is to get a leading “F” that makes valid validation results and “n_lead” counts. For example, if the leading “F” in “n lead” is 6, the valid verification result has 16 digits (the number of digits depending on the applition, and determined by the system committee), and the valid verification result is greater than or equal to FFFFFF0000000000.
Trying different values of parameter one and parameter two to get the ValidationOutput.
Target: ValidationOutput with the amount of n_lead of leading F.

If there are 16 total digits in this ValidationOutput.

For example, if n_lead=6, the target is ValidationOutput>=FFFFFF0000000000

### <Method2>

In an example embodiment, Method2 is applied for validation. There are several Replacement-Tables on step 910 that are provided by the system. In step 906, a plurality of clumps try different values of parameter one; in step 908, a plurality of clumps try different values of parameter two. If there are 16 total digits in this ValidationOutput. The target result is that “n_lead” with at least the leading “0” of 8, and the validation result needs to be less than or equal to 00000000FFFFFFFF.
Clumps obtain these Replacement-Tables whenever there is a software update.
Clumps may try to use any one of these Replacement-Tables on validation process.
As shown on Figure above, clumps still try different values of parameter one on step 906. Clumps try different values of parameter two on step 908, and use one of these Replacement-Tables on step 910.
Target: ValidationOutput with the amount of n_lead of leading 0.
If there are 16 total digits in this ValidationOutput; for example, if n_lead=8, ValidationOutput<=00000000FFFFFFFF

### <Method3>

In an example embodiment, Method3 is applied for validation.

Mt3_hash=the last n_metod3 digits of the hash of previous globule_conspectus

Mt3 ValidationOutput=The partial continuous nmetod3 digits of ValidationOutput (Step 914)

Target Requirement:

Mt3_hash=Mt3 ValidationOutput

That is:

The partial continuous nmetod3 digits of ValidationOutput should be exact the same as the last n_metod3 digits of the hash of previous globule_conspectus.

For example, the hash of previous globule_conspectus=0123 4567 89AB CDEF

The last five digit of the hash of previous globule_conspectus=BCDEF

The partial continuous five digits of ValidationOutput need to be exact the same as the last five digits of the hash of previous globule_conspectus.

These is some example instances that meet the target requirement.
01289ABCDEF34567
0123BCDEF456789A
01BCDEF456789A23
2BCDEF45678901A3

### <Method4>

In an example embodiment, Method4 is applied for validation.

Mt4_hash=The first n_method4 digits of the hash of previous globule_conspectus

Mt4_ValidationOutput=The remainder of modulus operation of ValidationOutput based on divisor Divr

(Mt4_ValidationOutput=ValidationOutput % Divr)

The variable divisor Divr is determined by the system.

Target Requirement:

Mt4_hash=Mt4_ValidationOutput

That is:

The remainder of modulus operation of ValidationOutput should be exact the same as the first nmetod4 digits of the hash of previous globule_conspectus.

### Example of Replacement by Table-Lookup

The raw data is represented in hexadecimal representation: xy for instance, the original hex is 8a

Looking up the table, x=8 (row) and y=a (column), we may found 7e.

Thus, the replacement is 8a replaced by 7e, as shown in FIG. 9B.

In FIG. 9A and FIG. 9C, in the embodiment where there is one or more look-up table 920 provided by the system 10, when a clump claims that the successful validation result of the globule and informs Asteroid_Clump_on_Duty, and the Asteroid_Clump_of_Backup, and all clumps on a transmission path the parameter one and parameter two, (and parameter three, if there are more than one look-up tables provided by the system) that the clump used for validation.

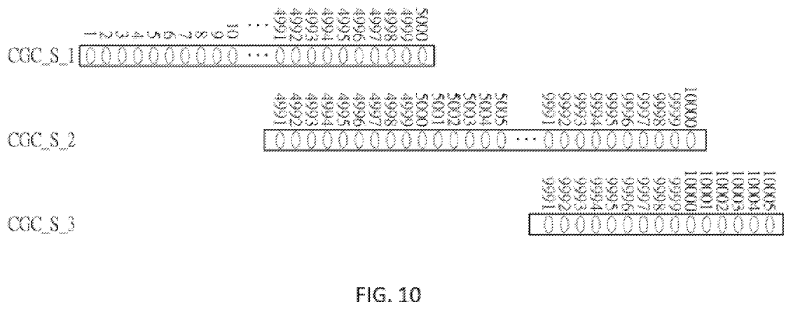

FIG. 10 is a schematic diagram of archiving the history of the Cardinal_Globule_Cluster in an embodiment of the present disclosure, which can be used in the process 30. FIG. 10 contains the first series CGC_S_1, the second series CGC_S_2 and the third series CGC_S_3 of the Cardinal_Globule_Cluster, wherein the first series CGC_S_1 contains globules GLB_1˜5000; and the second series CGC_S_2 contains globules GLB_4991˜10000; and the third series CGC_S_3 comprises globules GLB_9991-15000. Depending on the application, when the system 10 is running, the system 10 can set the number of globules in preparation (overlaping globules of two series) for the next series of progressions.

For example, for accommodation applications, the system can set the number of globules to be 5000. When the number of globules in the first series CGC_S_1 reaches 4991, the second series CGC_S_2 starts. The last 10 globules of the first series CGC_S_1 overlap with the first 10 globules of the second series CGC S 2, and the content in the overlapping globules is almost the same. The index values of overlapping globule in different series are somewhat different.

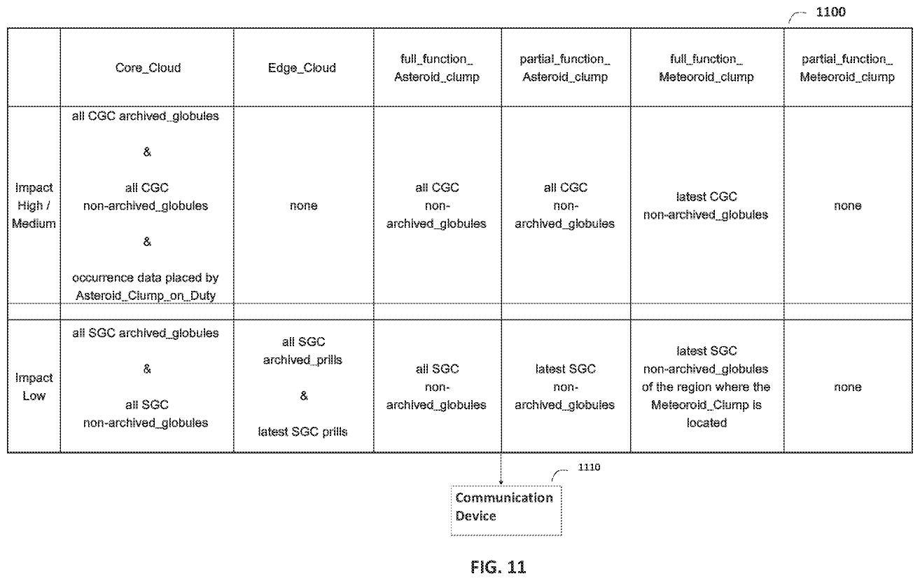

FIG. 11 is a data storage table 1100 for storing occurrence according to the impact level in an embodiment of the present disclosure, where data can be stored in the communication device 1110. The communication device 1110 can be the communication device 20 in FIG. 2. Impact levels include high/medium and low in FIG. 11. The storage locations comprise core cloud 100, edge cloud 110, fully functional Asteroid_Clump, partially functional Asteroid_Clump, fully functional Meteoroid_Clump, and partially functional Meteoroid_Clump. As shown in Table 110, the data of all Cardinal_Globule_Cluster historical archived globules of high/medium impact; all Cardinal_Globule_Cluster non-historical archived globules and occurrence data in Asteroid_Clump_on_Duty can be stored in the core_cloud 100.

The data of all Cardinal_Globule_Cluster with high/medium impact none_archived globules can be stored in the full_function Asteroid_Clump and partial function Asteroid_Clump. Data of the most recent Cardinal_Globule_Cluster none_archived globules of high/medium impact can be stored in full_function Meteoroid_Clump.

All archived globules of the Satellite_Globule_Cluster and all none_archived globules of the Satellite_Globule_Cluster with low impact levels can be stored in the core_cloud. The archived globules of all Satellite_Globule_Cluster and the latest Satellite_Globule_Cluster globules with low impact level can be stored in the edg_cloud.

All none_archived globules of Satellite_Globule_Cluster with low impact level can be stored in the fully function Asteroid_Clump. The none_archived globules of the latest Satellite_Globule_Cluster with low impact level can be stored in partial function Asteroid_Clump. The latest Satellite_Globule_Cluster none_archived globules in the region where the low-impact Meteoroid_Clumps are located can be stored in the full function Meteoroid_Clumps.

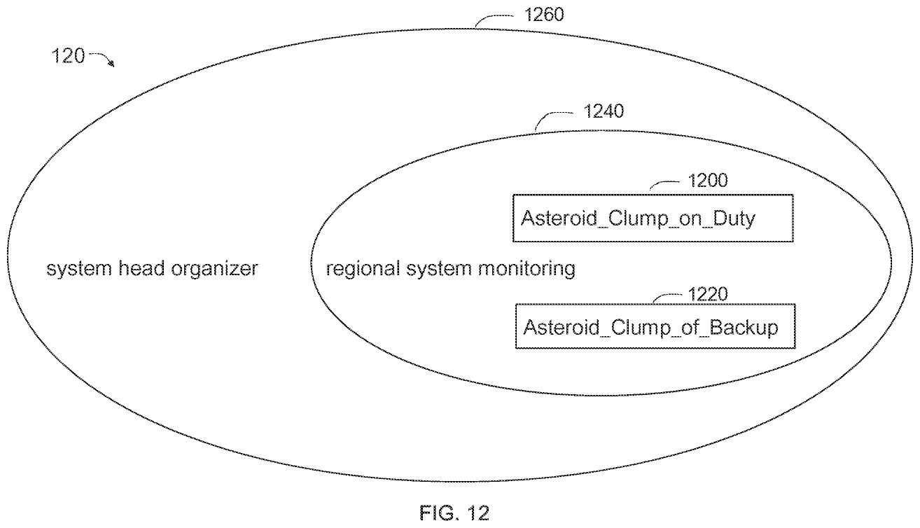

FIG. 12 is a schematic diagram of a fault tolerance mechanism 120 in an embodiment of the present disclosure, showing an Asteroid_Clump_on_Duty 1200, an Asteroid_Clump_of_Backup 1220, a regional system monitoring 1240 and a system head organizer 1260. As shown in FIG. 12, Asteroid_Clump_on_Duty 1200 and Asteroid_Clump_of_Backup 1220 are included in regional system monitoring 1240; and regional system monitoring 1240 is included in system head organizer 1260.

The Asteroid_Clump_of_Backup 1220 and the Asteroid_Clump_on_Duty 1200 play an important role in performing computing tasks in the operation of the system 10, and Asteroid_Clump_of_Backup 1220 supports the failure of Asteroid_Clump_on_Duty 1200. Regional system monitoring 1240 (information technology (IT) member) monitors the Asteroid_Clump_on_Duty 1200 and supports the operation of Asteroid_Clump_of_Backup 1220 for malfunctions. System head organizer 1260 (committee information technology member) monitors regional system monitoring 1240 to take appropriate countermeasures in the event that regional system monitoring 1240 fails in order to restore system 10 operation. That is to say, through the above-mentioned fault tolerance mechanism, when the Asteroid_Clump_on_Duty 1200, Asteroid_Clump_of_Backup 1220, and the regional system monitoring 1240 are faulty sometimes, the system 10 can still be operated normally.

These are some examples of applicable application embodiments. The system may be used for facilitating housing, health service, transportation service, international procurement, etc.

One of the examples service provided is accommodation service, dining service, and retail service based on this system. The other example service is health related service. These services may be applied to research institutes, universities, international houses, medical centers, and companies that participate in this system.

(a) Accommodation for Academic/Medical trip

For students living around campus, they usually don't live there during break. There are usually some empty rooms available at that time. The room available is usually inside or close to campus. These rooms may be released to visitors from other country based on this service. Visiting students, scholars, researchers may live in those empty rooms and participate meet-up in the campus of a university, an academic institution, or a medical center. In the long run, the service may be expanded to shops around campus, such as dining service around campus, or medical service that is provided by a medical center in the system.

Though remote video conference is a method to communicate, the result is not as good as in-person interaction in general. For instance, in-person demonstration is much more effective than remote viewing in art education. Another instance is medical service. There is some physical examination between a physician and a patient. It is not feasible for remote palpation.

For some medical institutions in some countries that provide medical service for people from other countries, these medical institutions may participate in this system. For example, if a comprehensive health examination is not available at a certain period of time, or the price is quite high in certain countries, a person who would like to have a comprehensive health examination may go to a country where this service may be done at that time with affordable price and good quality. (Sometimes, palpation or more in-depth health examination/surgery is required. For example, residents in some countries probably don't have access to good medical service. It would be good if they provide something to exchange with a medical service from a participating high-quality medical center in nearby areas.)

(b) Business trip:

Some employee dormitory or some hotels adjacent to a corporate campus may participate in this system. Employees of a company go to other city or other country to have a business trip. It is quite expensive to live in a hotel if the hotel does not offer special discount for the employee of this company. If the company does have dormitory close to the building of the company office, or if there are some hotels close to the office that participate in this system, the employees may live in the dormitory or participating hotels that are very close to the office. It saves traffic time commuting between office and dormitory/hotel. It also reduces energy consumption of transportation and air pollution produced during commuting. The system also allows some corporates to join.

The hotel inside or adjacent to the corporate/university/hospital campus may join the system after the meeting of the committee of the system. For a member in the system, the participating hotel may offer a long time frame to reside. If Employee_A at Location_A exchanges his room with the room of Employee_B at Location_B for the same period of time, the time frame could be as short as a few days, up to more than one year.

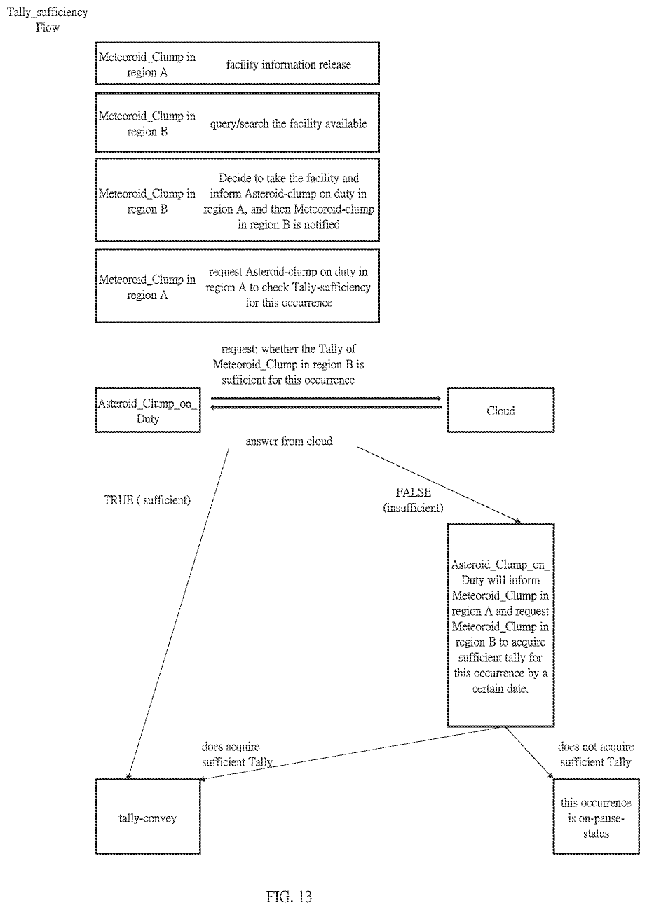

FIG. 13 illustrates a Tally_sufficiency checking process of an example of accommodation service of an embodiment of this system. Meteoroid_Clump in region A release facility information. Meteoroid_Clump in region B query and search the facility available. Meteoroid_Clump in region B decides to take the facility and inform Asteroid_Clump on duty in region A, and Meteoroid_clump in region B is notified. Meteoroid_Clump in region A requests Asteroid_Clump_on_Duty in region A to check Tally_sufficiency for this occurrence. Asteroid_Clump_on_Duty request the information whether the Tally of Meteoroid_Clump in region B is sufficient for this occurrence from Edge_Cloud. (If Edge_Cloud does have sufficient information, Edge_Cloud would obtain information from Core_Cloud.) If the answer from cloud is true, Tally_sufficiency check is done. If the answer from cloud is false, Asteroid_Clump_on_Duty will inform Meteoroid_Clump in region A and request Meteoroid_Clump in region B to acquire sufficient tally for this occurrence by a certain date. If Meteoroid_Clump in region B does acquire sufficient Tally by a certain date, Tally_sufficiency check is done. If not, this occurrence is on-pause-status.

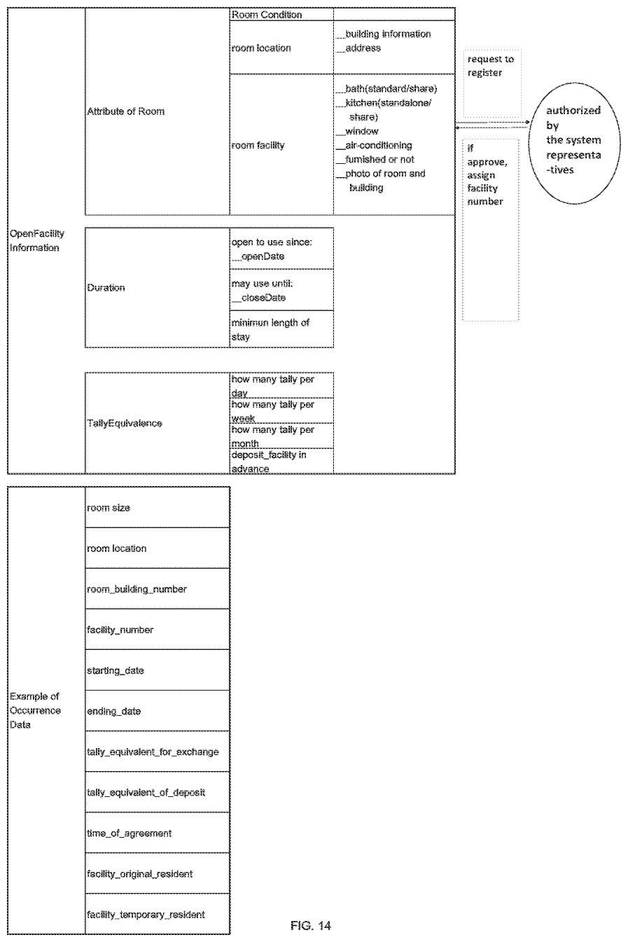

FIG. 14 illustrates an example of accommodation service through an embodiment of this system. Some member (e.g., Employee_A, Employee_B, Employee_C, Employee D) provide some information, such as room location, room facility, duration available, amount of equivalent tally of room exchange, to request for registering from application service representative. After the registration is completed, members in the system who intent to travel may find the appropriate matching of time, room condition, and equivalent tally. If these condition of exchange match these two member's (e.g., Employee_A, Employee_C) demand, Employee_A and Employee_C may inform the detail exchange condition to the system application service representative regarding the occurrence of room exchange. An example of occurrence data (such as room size,
room location, room building number, facility number, starting date, ending date, tally equivalent for exchange, tally equivalent of deposit, time of agreement, facility original resident, facility temporary resident) are shown in FIG. 14.

The advantage of this disclosure includes the following:

### Technology Aspect:

Scalable and high availability
Local autonomy
Secure
Convenient for users
Cost saving
Providing incentive for individual members. The operation of system requires teamwork of individual members and enterprise members. The role of individual members may balance the domination power of large enterprises.
Fault-tolerant
Proper resource allocation and sharing
Impact control
Organizational benefit: Integration of various hardware resources from individual members and organizational members

### Economy and Finance Aspect:

If the system is built, there are several benefits for people in the system:

Traveler reduce the loss of exchanging foreign currency.

For international procurement, a retail shop in the system may also take advantage of the reduced cost of foreign fund exchange when a shop imports/purchases products from various countries.

If there is no such a universal system across countries, people need to do currency exchange twice. The first time is before a person go abroad, he needs to change local currency to a foreign currency. The second time is that, after he comes back from foreign country, he needs to do exchange again back to local currency. There would be two currency exchange loss in these two exchanges which is earned by banks for foreign fund exchange. After implementing this system, most expense may be paid by this system without currency exchange loss.

### Housing and Transportation Application:

The cost of living is expensive in general. With this system, people may have housing service with minimum cost based on the concept of sharing.

It is also more convenient to live inside campus or around campus/office, comparing with living in a hotel which is far away from campus/office.

Traffic time can be saved if living within walking distance to campus, research center, office, or medical center.

The closed membership-based system allow users have better confidence and trust with the system.

Privacy: The close system also prevents the data from spreading to other people outside the system.

The above “information” may be replaced with “data”. The above-mentioned “compute” operation can be replaced by “calculate”, “obtain”, “generate”, “output”, “select”, “use”, “choose”, or “decide”. The above phrase “through (via)” may be replaced with “by”, “on”, “in”, or “at”.

The actual numerical values mentioned above are only used to illustrate the present disclosure, but not to limit the present invention. The term numbers above, such as “first”, “second” and “third” are only used to distinguish similar terms, and does not pose a limitation on the scope of the invention otherwise claimed. The use of any and all examples, or exemplary language (e.g. “such as’) provided with respect to certain embodiments herein is intended merely to better illuminate the invention and does not pose a limitation on the scope of the invention otherwise claimed.

Those skilled in the field may combine, modify and/or change the above-mentioned embodiments according to the spirit of the present invention, but are not limited thereto. The mentioned statements, modules, data structures and/or processes (including suggested steps) can be realized by means of devices, which can be hardware, software, firmware (a combination of hardware devices and computer instructions and data, and computer instructions, and read-only software on a hardware device), an electronic system, or a combination of the above devices. It will be apparent to one skilled in the art that other embodiments may be practiced apart from the specific details described below. In other instances, detailed descriptions of well-known methods, devices, techniques, etc. are omitted so as not to obscure the description with unnecessary detail.

The above descriptions are only preferred embodiments of the present disclosure, and all equivalent changes and modifications made according to the scope of the patent application of the present disclosure shall fall within the scope of the present disclosure.

What is claimed is:

1. A system of collaboratively processing occurrences of events, comprising:
an Edge_Cloud; and
a plurality of devices, wherein the devices are grouped into a plurality of clumps, comprising:
an Asteroid_Clump_on_Duty;
an Asteroid_Clump_of_Backup;
a plurality of Asteroid_Clumps;
at least one first Meteoroid_Clump; and
at least one second Meteoroid_Clump;
wherein the system is set up to perform operations comprising:
An occurrence of an event is generated by least one first Meteoroid_Clump; and the first Meteoroid_Clump transmits the information of the occurrence to the Asteroid_Clump_on_Duty;
The said first Meteoroid_Clump obtains an acknowledgment from the Asteroid_Clump_on_Duty, and transmits the information of the occurrence to the Asteroid_Clump_on_Duty, and the Asteroid_Clump_of_Backup, and at least one second Meteoroid_Clump that is closest in proximity to the first Meteoroid_Clump; wherein the closest at least one second Meteoroid_Clump excludes the Meteoroid_Clumps with poor response speed, poor network capability, poor hash power, or poor historical credit of the clump;
At least two of the clumps, among Asteroid_Clump_on_Duty, the Asteroid_Clump_of_Backup, the plurality of Asteroid_Clump, the second Meteoroid_Clump, and Edge_Cloud, perform a Tally_sufficiency check, a format verification, and a validation of the occurrence;
The clumps that successfully validate the occurrence informs Asteroid_Clump_on_Duty, and the Asteroid_Clump_of_Backup, and all clumps on a transmission path;
wherein the clumps perform Tally_sufficiency check, a format verification, and validation are located at each local edge.

2. The system as described in claim 1, wherein the plurality of devices are multiple personal computers, multiple tablet computers, multiple workstations, or multiple mobile devices;
The Asteroid_Clump_on_Duty performs the above-mentioned multiple operations times, until the amount of the Satellite_Globule_Cluster data and the amount of another Satellite_Globule_Cluster data are greater than a specific required threshold;
The Asteroid_Clump_on_Duty conducts the contest of validation among at least two of the said Satellite_Globule_Cluster data structure, and the winner of the contest of Satellite_Globule_Cluster data structure is written to a Cardinal_Globule_Cluster data structure;
A plurality of clumps historically archive the Cardinal_Globule_Cluster data structure.

3. The system as described in claim 1, further comprise a Cardinal_Globule_Cluster data structure;
The said Cardinal_Globule_Cluster data structure comprises a plurality of Cardinal_Globule_Cluster sphere data structure; wherein the Cardinal_Globule_Cluster sphere data structure comprise a plurality of Cardinal_Globule_Cluster sphere_circle data structure;
wherein the Cardinal_Globule_Cluster sphere_circle data structure comprises a plurality of Cardinal_Globule_Cluster globule data structure.

4. The system as described in claim 3, wherein the said Cardinal_Globule_Cluster globule data structure within the Cardinal_Globule_Cluster sphere data structure comprises a hash computation result of globule_conspectus of Cardinal_Globule_Cluster globule data structure of a plurality of previous Cardinal_Globule_Cluster spheres data structure.

5. The system as described in claim 4, wherein the globule index value of said Cardinal_Globule_Cluster globule data structure within the Cardinal_Globule_Cluster sphere data structure is the same globule index value of Cardinal_Globule_Cluster globule data structure of a plurality of previous Cardinal_Globule_Cluster spheres data structure.

6. The system as described in claim 1, wherein
a plurality of Satellite_Globule_Cluster globule data structure form Satellite_Globule_Cluster sphere_circle data structure;
a plurality of Satellite_Globule_Cluster sphere_circle data structure form Satellite_Globule_Cluster sphere data structure;
a plurality of Satellite_Globule_Cluster sphere data structure form Satellite_Globule_Cluster data structure.

7. The system as described in claim 1, wherein the selection of Asteroid_Clump_on_Duty is predetermined by the system.

8. The system as described in claim 7, wherein the selection of Asteroid_Clump_on_Duty is predetermined by the system based on at least one of these criteria:
Physical location or network proximity;
Historical Credit;
Regular review by the system committee.

9. The system as described in claim 1, wherein
the Asteroid_Clump_on_Duty, the Asteroid_Clump_of_Backup, the plurality of Asteroid_Clumps;
and the plurality of Meteoroid_Clump are connected to an Edge_Cloud through network.

10. The system as described in claim 1, wherein
the occurrence of event comprises a service exchange; and the service exchange comprises a stuff exchange, a privilege exchange, a knowledge exchange.

11. The system as described in claim 1, wherein the factors affect historical credit of a clump comprise:
the amount of successful validation completed by a clump;
the amount of correct computation but not fast enough that a clump claims to Asteroid_Clump_of_Backup;
the amount of almost reaching the requirement of validation processed by a clump;
the duration of time that tally has been kept by the clump.

12. The system as described in claim 1, wherein the Asteroid_Clump_on_Duty, the Asteroid_Clump_of_Backup, the plurality of Asteroid_Clumps, the plurality of the second Meteoroid_Clump, and Edge_Cloud perform the validation after format verification and Tally_sufficiency is completed.

13. The system as described in claim 1, wherein the information comprises an impact of an occurrence and a condition of exchange; wherein the impact of the occurrence comprises an importance of an occurrence, a gain of an occurrence, a loss of an occurrence; wherein the impact of transportation application occurrence comprises the urgency of the demand, the combination of time efficiency and energy reduction of overall arrangement.

14. The system as described in claim 1, wherein the globule_conspectus and globule constituent of the occurrence are written to the globule of Cardinal_Globule_Cluster or the globule of Satellite_Globule_Cluster, after the amount of passing validation-check based on the type of the clump is greater than the specific required threshold; wherein the type of cluster of requirement and the required threshold is predetermined.

15. A method of collaboratively processing occurrences of events, comprising:
generating, by least one first Meteoroid_Clump, an occurrence of an event; and
transmitting, by the first Meteoroid_Clump, the information of the occurrence to the Asteroid_Clump_on_Duty; and
obtaining, by the said first Meteoroid_Clump, an acknowledgment from the Asteroid_Clump_on_Duty; and
transmitting the information of the occurrence to the Asteroid_Clump_on_Duty, and the Asteroid_Clump_of_Backup, and at least one second Meteoroid_Clump that is closest in proximity to the first Meteoroid_Clump, wherein the closest at least one second Meteoroid_Clump excludes the Meteoroid_Clumps with poor response speed, poor network capability, poor hash power, poor historical credit of the clump; and
performing, by at least two of the clumps among Asteroid_Clump_on_Duty, the Asteroid_Clump_of_Backup, the plurality of Asteroid_Clump, the second Meteoroid_Clump, and Edge_Cloud, a format verification and a tally-sufficiency check of the information of the occurrence; and
performing, by at least two of the clump among Asteroid_Clump_on_Duty, the Asteroid_Clump_of_Backup, the plurality of Asteroid_Clump, the second Meteoroid_Clump, a validation of the occurrence; and
claiming through transmitting, by the clump successfully validates the occurrence, a message of successful validation to Asteroid_Clump_on_Duty, and the Asteroid_Clump_of_Backup, and all clumps on a transmission path; and
performing, by Asteroid_Clump_on_Duty, and the Asteroid_Clump_of_Backup, and all clumps on a transmission path, a validation-check; and
writing, by Asteroid_Clump_on_Duty, and the Asteroid_Clump_of_Backup, and all clumps on a transmission path, the occurrence to the globule after the amount of passing validation-check based on the type of the clump is greater than a specific required threshold.

16. A method of validating occurrences, comprising:
obtaining information from the globule data structure of previous globule, by a clump, and executing a hash operation; and
choosing a parameter one, by the clump, and executing summing operation of the hash of previous globule data and parameter one; and
choosing a parameter two, by the clump, and executing shifting operation of the result of summing operation in previous step by the digit of parameter two; and
executing, by the clump, a table-lookup operation from the result of shifting operation of previous step; and
executing, by the clump, a XOR operation to get a validation output from the result of table-lookup operation of previous step and a serial number of previous globule.

17. The method as described in claim 17, wherein the clump tries various values of parameter one and parameter two to find out whether the validation output is greater than or smaller than a specific required threshold; wherein threshold is determined by system committee.

18. The method as described in claim 17, wherein the clump tries various values of parameter one and parameter two to find out whether specific partial continuous digits of validation output is exactly the same as specific partial continuous digits of previous globule_conspectus, wherein the digit position and the amount of specific partial continuous digits is determined by system committee.

19. The method as described in claim 17, wherein the clump tries various values of parameter one and parameter two to find out whether the remainder of modulus operation of validation output is exactly the same as specific partial continuous digits of previous globule_conspectus, wherein divisor of modulus operation is determined by system committee; and the digit position and the amount of specific partial continuous digits is determined by system committee.

20. The method as described in claim 17, wherein the inputs of executing a XOR operation to get a validation output are the result of table-lookup operation of previous step and the information of current globule.
